(19) United States
(12) Patent Application Publication
(10) Pub. No.: US 2024/0292178 A1
(43) Pub. Date: Aug. 29, 2024

(54) RENDERERS, DECODERS, ENCODERS, METHODS AND BITSTREAMS USING SPATIALLY EXTENDED SOUND SOURCES

(71) Applicant: Fraunhofer-Gesellschaft zur Förderung der angewandten Forschung e.V., München (DE)

(72) Inventors: Simon SCHWÄR, Erlangen (DE); Yun-Han WU, Erlangen (DE); Jürgen HERRE, Erlangen (DE); Matthias GEIER, Erlangen (DE); Mikhail KOROTIAEV, Erlangen (DE)

(73) Assignee: Fraunhofer-Gesellschaft zur Förderung der angewandten Forschung e.V., München (DE)

(21) Appl. No.: 18/660,059

(22) Filed: May 9, 2024

Related U.S. Application Data
(63) Continuation of application No. PCT/EP2022/081304, filed on Nov. 9, 2022.

(30) Foreign Application Priority Data
Nov. 9, 2021 (EP) 21207344.9

(51) Int. Cl. H04S 7/00

(52) U.S. Cl. CPC H04S 7/305; H04S 7/303

(57) ABSTRACT

Embodiments according to the disclosure have a renderer for rendering, e.g. spatially rendering, an acoustic scene, wherein the renderer is configured to render, e.g. to reproduce, an acoustic impact of a diffuse sound (e.g. of a reverberation; e.g. of a late reverberation), which originates in a first spatial region (e.g. in a first Acoustically Homogenous Space, AHS; e.g. in a first room), in a second spatial region (e.g. in a second Acoustically Homogenous Space; e.g. in a second room; e.g. in a spatial region outside the first spatial region), using a spatially extended sound source, e.g. a SESS, e.g. as a spatially extended sound source, e.g. a spatially extended sound source which reproduces the diffuse sound, e.g. using a homogenous extended sound source algorithm, and also encoders, methods and bitstreams.

### CROSS-REFERENCE TO RELATED APPLICATIONS

This application is a continuation of co-pending International Application No. PCT/EP2022/081304, filed Nov. 9, 2022, which is incorporated herein by reference in its entirety, and additionally claims priority from European Application No. 21207344.9, filed Nov. 9, 2021, which is also incorporated herein by reference in its entirety

### TECHNICAL FIELD

Embodiments are related to renderers, decoders, encoders, methods and bitstreams to using Spatially Extended Sound Sources.

Embodiments according to the disclosure comprise apparatus and methods to simulate the propagation of diffuse sounds by portals using spatially extended sound sources.

### BACKGROUND

For example, for virtual reality and augmented reality applications, a challenging task may be the representation of sound propagation between different acoustic spaces, for example acoustic spaces with different acoustic properties.

Such a task may be especially challenging for virtual reality or augmented reality environments with many acoustically coupled spaces. In addition, further challenges may arise from the volatile character of an audio scene in which users may not have a predetermined position but may be able to freely move in real time within the acoustic scene and act as sound sources.

Therefore, it is desired to provide a concept which makes a better compromise between the achievable perceived impression of a rendered audio scene, the efficiency of a transmission of data used for the rendering of the audio scene and the efficiency of a decoding and/or rendering of the data.

### SUMMARY

An embodiment may have a renderer for rendering an acoustic scene, wherein the renderer is configured to render an acoustic impact of a diffuse sound, which originates in a first spatial region, and in a second spatial region, using a spatially extended sound source; and wherein the renderer is configured to render the acoustic impact of the diffuse sound using a spatially extended sound source which is placed at a portal between the first spatial region and the second spatial region and which reproduces the diffuse sound which originates from the first spatial region.

According to another embodiment, an audio decoder may have: a renderer as mentioned above, wherein the audio decoder is configured to obtain a geometry description of a portal from a bitstream and to map the geometry of the portal onto a listener-centered coordinate system, in order to obtain a geometry description of the spatially extended sound source for the reproduction of the diffuse sound.

Another embodiment may have an audio encoder for encoding an audio scene, wherein the audio encoder is configured to provide an encoded representation of one or more audio signals, and wherein the audio encoder is configured to provide definitions of one or more spatially extended sound sources, wherein geometrical characteristics of the spatially extended sound sources are based on geometrical characteristics of portals between acoustically homogenous spaces.

Another embodiment may have a method for rendering an acoustic scene, wherein the method has rendering an acoustic impact of a diffuse sound, which originates in a first spatial region, in a second spatial region, using a spatially extended sound source, which is placed at a portal between the first spatial region and the second spatial region and which reproduces the diffuse sound which originates from the first spatial region.

Still another embodiment may have a method for encoding an audio scene, wherein the method has providing an encoded representation of one or more audio signals, and wherein the method has providing definitions of one or more spatially extended sound sources, wherein geometrical characteristics of the spatially extended sound sources are based on geometrical characteristics of portals between acoustically homogenous spaces.

Another embodiment may have a non-transitory digital storage medium having stored thereon a computer program for performing the method for rendering an acoustic scene as mentioned above, upon the computer program being run by a computer.

Another embodiment may have a non-transitory digital storage medium having stored thereon a computer program for performing the method for encoding an audio scene as mentioned above, upon the computer program being run by a computer.

According to another embodiment, an audio bitstream may have: an encoded description of one or more spatial regions; and an encoded representation of an information describing an acoustic relation between at least two spatial regions, wherein the encoded representation of spatial regions has a description of a portal between two spatial regions.

Embodiments according to the disclosure comprise a renderer for rendering, e.g. spatially rendering, an acoustic scene, wherein the renderer is configured to render, e.g. to reproduce, an acoustic impact of a diffuse sound (e.g. of a reverberation; e.g. of a late reverberation), which originates in a first spatial region (e.g. in a first Acoustically Homogenous Space, AHS; e.g. in a first room), in a second spatial region (e.g. in a second Acoustically Homogenous Space; e.g. in a second room; e.g. in a spatial region outside the first spatial region), using a spatially extended sound source, e.g. a SESS, e.g. a spatially extended sound source which reproduces the diffuse sound, e.g. using a homogenous extended sound source algorithm.

The inventors recognized that an acoustic influence of a diffuse sound field from a first spatial region which is, as an example, acoustically coupled with a second spatial region, may be rendered (or represented or modeled) efficiently, using a spatially extended sound source.

In other words, based on an incorporation of a spatially extended sound source in a rendering procedure, for example by calculating a sound impression caused by the spatially extended sound source, for a listener in the second spatial region, for example a second room, a hearing impression may be achieved, in which the diffuse sound field, which originates in the first spatial region, e.g. a first room, is represented authentically.

The inventors recognized that usage of such a spatially extended sound source for the rendering may allow to provide an authentic hearing impression of the rendered audio scene, whilst limiting a for example negative impact (e.g. with regard to an increase in needed data or computational costs) on a transmission and processing (e.g. decoding and/or rendering) of data needed for the provision of the audio scene.

According to further embodiments of the disclosure, the renderer is configured to render a direct-sound acoustic impact of a given sound source, which is located in the first spatial region, in the second spatial region using a direct-sound rendering.

Furthermore, the renderer is configured to render a diffuse-sound acoustic impact of the given sound source, e.g. the acoustic impact of the diffuse sound, which originates in the first spatial region, in the second spatial region using the spatially extended sound source.

It is to be noted that embodiments are not limited to rendering or representing diffuse-sound acoustic impacts and direct acoustic impacts of a same sound source. A renderer according to embodiments may be configured to render an audio scene comprising a plurality of sound sources of which some may provide a diffuse sound and some may provide a direct sound for a respective listener for which the scene is rendered (or both respectively).

However, such a plurality of sound sources may as well be modeled as a single sound source having a direct-sound acoustic impact and a diffuse-sound acoustic impact, which may respectively be aggregated versions of the acoustic impacts of the plurality of sound sources.

As an example, a sound source, such as a person speaking in a first room, may be audible for a listener in a second room. The listener may hear speech of the speaker as a direct sound acoustic impact, as well as a second sound, which is caused by late reverberations of the speech within the first room, as a diffuse-sound acoustic impact.

The inventors recognized that using separate rendering approaches, in the form of a usage of a direct-sound rendering and a usage of a spatially extended sound source, allow to provide an authentic hearing impression.

According to further embodiments of the disclosure, the renderer is configured to apply a direct source rendering, e.g. a binaural rendering, which may, for example, consider direct propagation, occlusion, diffraction, etc., to a sound source signal of a given sound source, which is located in the first spatial region, in order to obtain a rendered direct sound source response at a listener position which is located in the second spatial region.

In addition, the renderer is configured to apply a reverberation processing (e.g. a reverberation processing which generates a late reverberation (effect), e.g. a reverberation which is based on a combination of reflected signals undergoing multiple reflections, e.g. a reverberation after the early reflections have faded into densely and statistically distributed reflections) to the sound source signal of the given sound source, in order to obtain one or more reverberated versions of the sound source signal of the given sound source.

Furthermore, the renderer is configured to apply a spatially extended sound source rendering to the one or more reverberated versions of the sound source signal of the given sound source, in order to obtain a rendered diffuse sound response at the listener position which is located in the second spatial region.

This may allow to disburden or relieve a bitstream, since the renderer may be configured to simulate or model or represent the diffuse sound field and/or respectively the diffuse-sound acoustic impact, based on the reverberation processing to the sound source signal of the sound source.

Hence, for the given sound source only one sound source signal may have to be transmitted, e.g. instead of two signals, a first of which would represent a direct sound signal of the source and a second of which would represent a diffuse sound signal of the source.

According to further embodiments of the disclosure, the renderer is configured to render an acoustic impact of a late reverberation, e.g. of a reverberation; e.g. of a late reverberation, which is excited by a sound source located in the first spatial region (e.g. in a first Acoustically Homogenous Space, AHS; e.g. In a first room, in the second spatial region (e.g. in a second Acoustically Homogenous Space; e.g. in a second room; e.g. in a spatial region outside the first spatial region), using the spatially extended sound source, e.g. a SESS, e.g. as a spatially extended sound source, that reproduces the late reverberation.

The inventors recognized that an acoustic influence of a late reverberation in an acoustically coupled, but separate location, may be represented authentically and/or efficiently using the spatially extended sound source.

According to further embodiments of the disclosure, the renderer is configured to render the acoustic impact of the diffuse sound, e.g. of a reverberation; e.g. of a late reverberation, using a spatially extended sound source (e.g. as a spatially extended sound source), e.g. a SESS, that has similar spectral content in each spatial region. Hence, such a spatially extended sound source may be provided with low complexity, and may, for example represent an AHS and/or a portal between AHSs well.

According to some embodiments of the disclosure, which implement one of the concepts described herein (sometimes also designated as “method 2)”, the renderer is configured to render the acoustic impact of the diffuse sound using a spatially extended sound source which is placed at a portal between the first spatial region and the second spatial region and which reproduces the diffuse sound (or for example an acoustic impact of the diffuse sound) which originates from the first spatial region.

An acoustic coupling of rooms may be represented using portals. Such a portal is a geometric object with a spatial extent. In order to authentically provide an impact of a diffuse sound, originating from an acoustically coupled room, the inventors recognized that, for a listener, an impression of a spatial sound source at an interface of the coupled rooms may be advantageous.

Hence, the inventors recognized that in some cases placing a spatially extended sound source at the portal between the first spatial region and the second spatial region may be used in order to provide such an authentic hearing impression. In other words, a spatially extended sound impact (e.g. as a representation of a diffuse sound impact) for a listener in a second room from, e.g. originating in, an acoustically coupled first room may be provided.

Furthermore, it is to be noted that according to such an inventive concept, an additional consideration of occlusion effects, for example of geometric boundaries such as walls of respective spatial regions, may be omitted by the renderer, since the position of the portal within the scene may allow to directly incorporate, or may even by itself be, an information about acoustically effective or acoustically impactful, and hence ‘un-occluded’, interface regions in between the spatial regions.

However, the renderer may, for example, take occlusion effects based on objects within a room of the listener into account anyways or additionally.

According to further embodiments of the disclosure which implement one of the concepts described herein (sometimes also designated as “method 1”), the renderer is configured to render the acoustic impact of the diffuse sound using a spatially extended sound source which takes a geometric extent, e.g. size and/or shape, of the first spatial region (e.g. a same spatial extension like the first spatial region, e.g. a shrunk or downscaled version of the first spatial region, for example to avoid overlapping boundaries, for example while taking a same shape), and which reproduces the diffuse sound which originates from the first spatial region, taking into consideration an occlusion of the spatially extended sound source (e.g. by walls between the first spatial region and the second spatial region, or by any other materials which are acoustically attenuating or acoustically impermeable) at a listener position located within the second spatial region.

The inventors recognized that by setting a geometric extent of the spatially extended sound source to a geometric extent of the first spatial region, a good trade-off between complexity and a quality of the acoustic representation of the impact of the diffuse sound may be achieved.

As indicated above, an advantage of this approach may, for example, be that irrespective of a position of a listener, the geometric extent of the spatially extended sound source which reproduces the diffuse sound which originates from the first spatial region may simply be set to the geometric extent of the first spatial region, e.g. regardless of whether the listener is in a second, third or fourth spatial region.

Hence, there may be no need to locate a portal and hence, no need to place the spatially extended sound source to the portal, based on a listener position and corresponding interface regions between a spatial region of the listener and the first spatial region, from which the diffuse sound originates.

However, in order to incorporate occlusion effects, the renderer is configured to take into consideration an occlusion of the spatially extended sound source at the listener position, located within the second spatial region.

As an example, this may allow to unburden a bitstream, since no portal placement information may have to be provided to the renderer, wherein, for example, the renderer may take occlusions between a listener's position and the spatially extended sound source into consideration at its end. Furthermore, a corresponding encoding procedure may be simplified.

For example, using this approach, the space (or room) itself is the portal, and this entire radiating volume is “clipped” by an occlusion/shadowing computation in the virtual reality system (or in the renderer).

According to further embodiments of the disclosure, the first spatial region is a first acoustically homogenous space, e.g. a space or region with identical late reverb, .e.g. late reverberation, characteristics. Alternatively or in addition, the second spatial region is a second acoustically homogenous space, e.g. a space or region with identical late reverb characteristics.

The inventors recognized that the inventive concept may be especially advantageously applied for acoustically homogenous spaces, for example, with regard to the ability of embodiments to provide an authentic hearing impression for a diffuse sound field originating from and/or being provided to an acoustically homogenous space.

According to further embodiments of the disclosure, the first spatial region and the second spatial region are rooms, e.g. physically adjacent rooms, or physically separate rooms, comprising a telepresence structure as a portal, which are acoustically coupled via a portal, e.g. via a door, and/or via one or more walls which are at least partially permeable for sound, or via a telepresence structure.

This may allow to provide an immersive hearing expression.

According to further embodiments of the disclosure, the renderer is configured to render a plurality of spatially extended sound sources comprising one or more spatially extended sources, which are distant from a listener position, and which may, for example, take the full space (or a shrunk portion) of respective acoustic homogenous spaces or rooms, and one or more spatially extended sources, inside of which the listener position is located, and which may, for example, take the full space (or a shrunk portion) of respective homogenous spaces or rooms, using a same rendering algorithm, taking into account occlusions between the listener position and the one or more spatially extended sources which are distant from the listener position.

It is to be noted that in general, according to embodiments, spatially extended sound sources or portals (e.g. spatially extended sound sources representing portals) can, for example, be obtained by shrinking the geometry of the corresponding spatial space, e.g. slightly, in order to avoid overlap between the geometry of the spatially extended sound source or portal and potential occluding boundaries, e.g. of spatial regions.

According to further embodiments of the disclosure, the renderer is configured to perform a binaural rendering. Embodiments may allow an authentic provision of a hearing experience for a headphone user.

According to further embodiments of the disclosure, the renderer is configured to determine (e.g. using a ray-tracing based approach, e.g. taking into account occlusion and/or attenuation) in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound lies, and to render the spatially extended sound source in dependence thereon.

This may allow to provide a precise spatial hearing experience for the listener. Furthermore, an influence of additional acoustically relevant scene objects and/or characteristics between listener and the spatially extended sound source may be taken into account.

According to further embodiments of the disclosure, the renderer is configured to determine, e.g. using a ray-tracing based approach, e.g. taking into account occlusion and/or attenuation, in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound is occluded, and to render the spatially extended sound source in dependence thereon.

Hence, occlusion effects may be incorporated accurately for a rendering of an audio scene.

According to further embodiments of the disclosure, the renderer is configured to determine in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound lies using a ray-tracing based approach.

According to further embodiments of the disclosure, the renderer is configured to determine in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound is occluded using a ray-tracing based approach.

The inventors recognized that a ray-tracing based approach may allow to efficiently determine the location of the spatially extended sound source relative to the listener, as well as acoustically relevant objects (e.g. for further occlusion effects) in between, and may hence allow to accurately render an audio scene for the listener.

According to further embodiments of the disclosure, the renderer is configured to determine, e.g. taking into account occlusion, for a plurality of areas (e.g. areas on a surface which is in a predetermined relationship with a listener's position, or areas on a hull surrounding a listener's position), whether a ray associated with a respective area and extending away, e.g. outward, from a listener's position, e.g. through the respective area, or starting on the respective area, hits the spatially extended sound source (a geometry of which may, for example, be determined by mapping a geometry definition in coordinates relative to an auditory scene (or relative to a coordinate system origin of an auditory scene) into coordinates relative to a listener), to thereby determine in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound lies.

As an example, rays may be used to help render Spatially Extended Sound Sources (SESSs). In a virtual 3D scene that may, for example comprise, optionally only the meshes of all SESSs (e.g. including portals), a predefined number of rays may be cast into all directions. This may be done in each update cycle, given that any relevant scene object or the listener position has changed. For each extended source/portal, the ray hits may be stored. This information is then used in later stages addressing occlusion and/or homogeneous extent.

In an update cycle, a number of primary rays may be cast in all directions, measured relative to a listener's orientation. The list of ray directions may be stored in a list in the source code. All ray hits that are caused by an intersection of a ray with a source extent geometry (including portal geometries or spatially extended sound source geometry) may be stored. However, there may, for example, be a distinction between a ray hitting the outside or the inside of an extent geometry. If one ray hits the same extent geometry multiple times, optionally only the closest hit may, for example, be considered.

For each primary ray, a number of additional rays may, for example, be cast in a pattern, e.g. in a circular pattern. These secondary rays may start at the same point as the primary ray, and may pass through a number of points, for example, equi-distributed on a circle of a predetermined radius on a plane, e.g. perpendicular to the primary ray's direction at a predetermined distance from the listener

The primary ray and all of the additional rays may be given an equal weight. For each ray that hits a source extent geometry, its weight may be added to the total weight associated with its primary ray's ID.

All rays with a non-zero weight may be stored in an item, such as render item, RI, or encoder item for later stages to consume.

In a second loop over all RIs, additional refined rays may, for example, be cast for extent geometries that have been hit by fewer rays than defined by a threshold. For each of the primary rays that hit the geometry, a number of secondary rays may be cast in a pattern, e.g. a circular patterns:

The primary ray and all of the secondary rays may, for example be given an equal weight. For each ray that hits a source extent geometry, its weight may be added to the total weight associated with its primary ray's ID. In the record associated to the primary ray's ID, for each of the rays a bit may be set to 1 if the corresponding ray hits the geometry and to 0 Otherwise.

According to further embodiments of the disclosure, the renderer is configured to determine, e.g. using a lookup table mapping different spatial regions (e.g. spatial regions of different position relative to the user, and/or spatial regions of different extensions) onto values of one or more cue information items, one or more auditory cue information items (e.g. an inter-channel correlation value, and/or an inter-channel phase difference value, and/or an inter-channel time difference value, and/or an inter-channel level difference value, and/or one or more gain values) in dependence on the spatial region in which the spatially extended sound source for the reproduction of the diffuse sound lies.

Furthermore, the renderer is configured to process one or more audio signals representing the diffuse sound using the one or more auditory cue information items, in order to obtain a rendered version of the diffuse sound, e.g. rendered for the listener at the listening position.

The inventors recognized that based on a determination and processing of auditory cue information items, the hearing impression of a rendered version of a diffuse sound may be improved.

According to further embodiments of the disclosure, the renderer is configured to update the determination, in which spatial region, e.g. in which horizontal/vertical region or in which azimuth/elevation region, relative to a listener's position and/or a listener's orientation, e.g. seen from the listener's point of view, the spatially extended sound source for the reproduction of the diffuse sound lies, in response to a movement of the listener, e.g. in response to a change of the listener's position, and/or in response to a change of the listeners viewing direction.

Alternatively or in addition, the renderer is configured to update the determination of the one or more auditory cue information items in response to a movement of the listener, e.g. in response to a change of the listener's position, and/or in response to a change of the listeners viewing direction.

Furthermore, alternatively or in addition, the renderer is configured to update the determination of the one or more cue information items in response to a change of the spatial region in which the spatially extended sound source for the reproduction of the diffuse sound lies.

In general, a renderer according to embodiments may be configured take a change of relative positions, e.g. of listener, spatial regions, portals and/or spatially extended sound sources, into consideration for a rendering of a respective audio scene.

The inventors recognized that inventive concepts, for example using a portal and spatially extended sound sources at a position of the portal and/or sound sources having a spatial extent (or a shrunk version) of a corresponding spatial region, may allow to efficiently incorporate a dynamic change of the scene, e.g. based on a movement of a listener and/or a change of the spatial region in which the spatially extended sound source is.

Hence, embodiments may allow a real time adaptation of a dynamic audio scene.

Furthermore, the inventors recognized that for such an adaptation, not only, for example direct, positional updates may be performed, e.g. the determination, in which spatial region the spatially extended sound source lies, but alternatively or in addition, a determination of auditory cue information items may be updated, in order to represent a respective change in the audio scene efficiently.

Further embodiments according to the disclosure comprise an audio decoder, the audio decoder comprising a renderer according to any of the embodiments as disclosed herein, wherein the audio decoder is configured to obtain a geometry description of a portal, e.g. of one or more spatially extended sound sources for a reproduction of diffuse sound, from a bitstream and to map the geometry of the portal onto a listener-centered coordinate system, in order to obtain a geometry description of the spatially extended sound source for the reproduction of the diffuse sound.

Hence, in general, it is to be noted that according to embodiments a portal may be or may comprise a functionality of one or more spatially extended sound sources. Therefore, a geometry description of a portal may be used as or for a geometry description of a spatially extended sound source. According to some embodiments of the disclosure, portals and SESS may be used interchangeably.

Furthermore, the inventors recognized that computational power on a side of the renderer or decoder may be saved, if such a geometry description is provided in a bitstream, and such that a corresponding renderer does not have to determine a respective geometry description of such a portal.

Accordingly, for an efficient cooperation between encoder, e.g. providing said bitstream, and renderer, the inventors recognized that the above explained mapping functionality may be advantageously present within the decoder.

Accordingly, and as an example, the inventors recognized that a renderer may represent an audio scene in a listener centered coordinate system, in order to efficiently render the audio scene for the respective listener.

According to further embodiments of the disclosure, the audio decoder is configured to obtain two or more signals, which are at least partially decorrelated, for the rendering of the spatially extended sound source derived from the output of a late reverb generator.

The inventors recognized that a spatially extended sound source may be rendered efficiently using, or based on, two or more signals, which are at least partially decorrelated. Optionally, both signals may have a same power spectral density.

According to further embodiments of the disclosure, the audio decoder is configured to obtain two or more signals for the rendering of the spatially extended sound source using a feedback delay network reverberator, wherein the two or more signals may, for example, serve as signals representing the diffuse sound.

The inventors recognized that a feedback delay network reverberators may provide efficient means to provide the at least partially decorrelated signals. Optionally, both signals may have the same power spectral density.

According to further embodiments of the disclosure, the decoder is configured to use a sound source signal and a decorrelated version of the sound source signal, which may, for example, be derived from the sound source signal using a decorrelator which may be part of the audio decoder, for the rendering of the spatially extended sound source, wherein the sound source signal and the decorrelated sound source signal may, for example, serve as signals representing the diffuse sound.

The inventors recognized that a single signal may be processed in order to provide two at least partially and/or approximately decorrelated signals for the rendering of the spatially extended sound source. Hence, less input signals may be needed. Optionally, both signals may have a same power spectral density.

According to further embodiments of the disclosure, the decoder is configured to exclude or attenuate occluded spatial regions when rendering the spatially extended sound source, e.g. using an equalization or attenuation in dependence on an occluder's absorption properties.

In general and as an example, a decoder according to embodiments may comprise a pre-processing unit for the renderer, which may be configured to provide decorrelated signals for rendering the spatially extended sound source and/or which may be configured to perform a spatial pre-processing, e.g. comprising a determination of relative locations of acoustically relevant objects, in order to equalize or attenuate acoustic influences.

According to further embodiments of the disclosure, the decoder is configured to allow for a smooth transition in-and-out of and in-between multiple spatial regions, e.g. between multiple acoustically homogenous spaces, e.g. by fading out a spatially extended sound source which represents the diffuse sound and fading in a non-localized rendering the of the diffuse sound when the listener is approximating a transition, e.g. a portal, between the first spatial region and the second spatial region.

This may allow to provide an authentic hearing impression for a listener.

In the following embodiments related to an encoder are discussed. It is to be noted that such embodiments may be based on the same or similar or corresponding considerations as the above embodiments related to a decoder. Hence, the following embodiments may comprise same, similar or corresponding features, functionalities and details as the above disclosed embodiments, both individually and taken in combination.

Further embodiments according to the disclosure comprise an audio encoder for encoding an audio scene, wherein the audio encoder is configured to provide an encoded representation of one or more audio signals, e.g. to encode the one or more audio signals, e.g. as a part of an encoded representation of the audio scene.

Furthermore, the audio encoder is configured to identify a plurality of acoustically homogenous spaces and to provide definitions, e.g. a geometry description, of spatially extended sound sources on the basis thereof, wherein geometrical characteristics, e.g. positions and/or dimensions, of the spatially extended sound sources are identical to geometrical characteristics, e.g. positions and/or dimensions, of the identified acoustically homogenous spaces, wherein the audio encoder may, for example, be configured to include the definitions of the spatially extended sound sources into an encoded representation of the audio scene, e.g. into a bitstream.

It is to be noted that only some geometric characteristics may be identical, e.g. such as a position (e.g. as a center of an area) and/or a shape, but wherein other characteristics may be different, for example outer dimensions of the spatially extended sound source which may, for example, be a scaled version of an identified acoustically homogenous space.

According to further embodiments of the disclosure, the audio encoder is configured to provide definitions, e.g. geometry descriptions, of acoustic obstacles, e.g. walls, or other occlusions, between the acoustically homogenous spaces, wherein the audio encoder may be configured to include the definitions of the acoustic obstacles into an encoded representation of the audio scene, e.g. into a bitstream.

Optionally, the audio encoder may be configured to selectively provide definitions of acoustic obstacles between the acoustically homogenous spaces.

For example based on a ray tracing, a renderer may efficiently select provided acoustically relevant obstacles in order to provide an authentic hearing impression for a listener.

According to further embodiments of the disclosure, the audio encoder is configured to provide an encoded representation of one or more audio signals, e.g. to encode the one or more audio signals, e.g. as a part of an encoded representation of the audio scene.

Furthermore, the audio encoder is configured to provide definitions, e.g. a geometry description, of one or more spatially extended sound sources, wherein geometrical characteristics, e.g. a location and/or an orientation and/or a dimension, of the spatially extended sound sources are based on, e.g. are equal to, geometrical characteristics of portals (e.g. openings, or doors, or acoustically permeable materials, or any medium that enables sound propagation between two spatial regions or between two acoustically homogenous spaces) between, for example physically and/or logically, e.g. adjacent, acoustically homogenous spaces.

Optionally, the audio encoder may, for example, be configured to include the definitions of the spatially extended sound sources into an encoded representation of the audio scene, e.g. into a bitstream.

According to further embodiments of the disclosure, the audio encoder is configured to identify a plurality of acoustically homogenous spaces and one or more portals between the acoustically homogenous spaces, e.g. by analyzing a geometrical relationship between the acoustically homogenous spaces, and to provide definitions, e.g. a geometry description, of one or more spatially extended sound sources on the basis thereof, wherein geometrical characteristics, e.g. positions and/or orientations and/or dimensions, of the one or more spatially extended sound sources are based on dimensions of the identified portals.

Optionally, the audio encoder may, for example, be configured to include the definitions of the spatially extended sound sources into an encoded representation of the audio scene, e.g. into a bitstream.

Optionally, the audio encoder may, for example, be configured to provide definitions, e.g. geometry descriptions, of acoustic obstacles, e.g. walls, or other occlusion, between the acoustically homogenous spaces, wherein the audio encoder may, for example, be configured to include the definitions of the acoustic obstacles into an encoded representation of the audio scene, e.g. into a bitstream.

In the following embodiments related to methods are discussed. It is to be noted that such embodiments may be based on the same or similar or corresponding considerations as the above embodiments related to decoders and/or encoders. Hence, the following embodiments may comprise same, similar or corresponding features, functionalities and details as the above disclosed embodiments, both individually and taken in combination.

Further embodiments according to the disclosure comprise a method for rendering, e.g. spatially rendering, an acoustic scene, wherein the method comprises rendering, e.g. reproducing, an acoustic impact of a diffuse sound, e.g. of a reverberation; e.g. of a late reverberation, which originates in a first spatial region (e.g. in a first Acoustically Homogenous Space, AHS; e.g. In a first room), in a second spatial region (e.g. in a second Acoustically Homogenous Space; e.g. in a second room; e.g. in a spatial region outside the first spatial region), using a spatially extended sound source, e.g. a SESS, e.g. a s a spatially extended sound source, e.g. a spatially extended sound source which reproduces the diffuse sound e.g. using a homogenous extended sound source algorithm.

Further embodiments according to the disclosure comprise a method for encoding an audio scene, wherein the method comprises providing an encoded representation of one or more audio signals, e.g. to encode the one or more audio signals, e.g. as a part of an encoded representation of the audio scene.

The method comprises identifying a plurality of acoustically homogenous spaces and providing definitions, e.g. a geometry description, of spatially extended sound sources on the basis thereof, wherein geometrical characteristics, e.g. positions and/or dimensions, of the spatially extended sound sources are identical to geometrical characteristics, e.g. positions and/or dimensions, of the identified acoustically homogenous spaces.

Optionally, the audio encoder may, for example, be configured to include the definitions of the spatially extended sound sources into an encoded representation of the audio scene, e.g. into a bitstream.

Further embodiments according to the disclosure comprise a method for encoding an audio scene, wherein the method comprises providing an encoded representation of one or more audio signals, e.g. to encode the one or more audio signals, e.g. as a part of an encoded representation of the audio scene.

Furthermore, the method comprises providing definitions, e.g. a geometry description, of one or more spatially extended sound sources, wherein geometrical characteristics, e.g. a location and/or an orientation and/or a dimension, of the spatially extended sound sources are based on, e.g. are equal to, geometrical characteristics of portals (e.g. openings, or doors, or acoustically permeable materials, or any medium that enables sound propagation between two spatial regions or between two acoustically homogenous spaces) between, for example physically and/or logically, e.g. adjacent, acoustically homogenous spaces.

Optionally, the audio encoder may, for example, be configured to include the definitions of the spatially extended sound sources into an encoded representation of the audio scene, e.g. into a bitstream.

Further embodiments according to the disclosure comprise computer program for performing a method according to any of the embodiments as disclosed herein, when the computer program runs on a computer.

In the following embodiments related to bitstreams are discussed. It is to be noted that such embodiments may be based on the same or similar or corresponding considerations as the above embodiments related to decoders, encoders and/or methods. Hence, the following embodiments may comprise same, similar or corresponding features, functionalities and details as the above disclosed embodiments, both individually and taken in combination.

Further embodiments according to the disclosure comprise an audio bitstream, comprising an encoded representation of one or more audio signals and an encoded representation of one or more spatially extended sound sources for rendering, e.g. reproducing, an acoustic impact of a diffuse sound, e.g. of a reverberation, e.g. of a late reverberation, which originates in a first spatial region (e.g. in a first Acoustically Homogenous Space, AHS; e.g. In a first room), and is rendered in a second spatial region (e.g. in a second Acoustically Homogenous Space; e.g. in a second room; e.g. in a spatial region outside the first spatial region).

Further embodiments according to the disclosure comprise an audio bitstream, comprising an encoded description of one or more spatial regions, e.g. of a plurality of spatial regions, e.g. an acoustic description of the one or more spatial regions and/or a geometry description of the one or more spatial regions, and an encoded representation of an information describing an acoustic relation between at least two spatial regions, e.g. between at least two spatial regions which are described by the encoded description.

Optionally the bitstream may, for example, also comprise an encoded representation of one or more audio signals or audio channels, e.g. representing audio sources that are located in one or more of the spatial regions.

The inventors recognized that a provision of information describing an acoustic relation between at least two spatial regions may improve a quality of a rendered acoustic scene comprising the at least two spatial regions, since an incorporation of acoustic coupling effects between the spatial regions may be simplified for a respective renderer.

According to further embodiments of the disclosure, the encoded representation of spatial regions comprises a description of a portal between two spatial regions, e.g. a description of a size of an opening between two spatial regions, and/or a description of an attenuation factor of an opening or an acoustic border between two spatial regions.

Hence, such portal for a coupling of the spatial regions may be provided to the renderer via the bitstream. This way, computational capacity for a determination of such a portal, e.g. to incorporate acoustic coupling effects between spatial regions, may be saved in the renderer.

According to further embodiments of the disclosure, the audio bitstream comprises an encoded representation of a propagation factor describing an acoustic propagation from the first spatial region to the second acoustic region.

The inventors recognized that incorporating a propagation factor into the bitstream may, for example, allow to provide an information about an acoustic coupling of the spatial regions with low transmission costs and evaluation effort, whilst allowing to render a respective acoustic scene authentically.

According to further embodiments of the disclosure, the audio bitstream comprises a propagation factor describing the amount/fraction of acoustic energy of a first spatial region, e.g. space #1, is radiated into a second spatial region, e.g. space #2, and optionally the other way round.

According to further embodiments of the disclosure, the audio bitstream comprises a propagation factor describing a ratio between a connected surface area between a first space and a second space and an entire absorption surface area of the first space.

The inventors recognized that a definition of a propagation factor with regard to an acoustic energy and/or a ratio between a connected surface area may allow an efficient representation of acoustic coupling effects.

According to further embodiments of the disclosure, the audio bitstream comprises a parameter describing a range, e.g. an extent, of a transition zone between two spatial regions, e.g. between two acoustically homogenous spaces.

This may provide an information for a geometric extent of a portal or respectively SESS. Hence, a rendering procedure may be simplified, by providing such an information already in the bitstream.

### BRIEF DESCRIPTION OF THE DRAWINGS

The drawings are not necessarily to scale, emphasis instead generally being placed upon illustrating the principles of the disclosure. In the following description, various embodiments of the disclosure are described with reference to the following drawings, in which:

FIG. 1 shows a schematic view of a renderer according to embodiments of the disclosure;

FIG. 2 shows a schematic view of a renderer with additional optional features, according to embodiments of the disclosure;

FIG. 3 shows a schematic view of a decoder according to embodiments of the disclosure;

FIG. 4 shows a schematic view of an encoder according to embodiments of the disclosure;

FIG. 5 shows a schematic view of an encoder according to further embodiments of the disclosure;

FIG. 6 shows a schematic block diagram of a method for rendering an acoustic scene according to embodiments of the disclosure;

FIG. 7 shows a schematic block diagram of a method for encoding an audio scene according to embodiments of the disclosure;

FIG. 8 shows a schematic block diagram of a method for encoding an audio scene according to embodiments of the disclosure;

FIG. 9 shows a schematic block diagram of a bitstream according to embodiments of the disclosure;

FIG. 10 shows a schematic block diagram of a pipeline of an inventive method according to embodiments of the disclosure;

FIG. 11 shows a schematic view of an example of the portal detection method 1 according to embodiments of the disclosure; and

FIG. 12 shows a schematic view of an example of the portal detection method 2 according to embodiments of the disclosure.

### DETAILED DESCRIPTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present disclosure. However, it will be apparent to those skilled in the art that embodiments of the present disclosure may be practiced without these specific details. In other instances, well-known structures and devices are shown in block diagram form rather than in detail in order to avoid obscuring embodiments of the present disclosure. In addition, features of the different embodiments described herein after may be combined with each other, unless specifically noted otherwise.

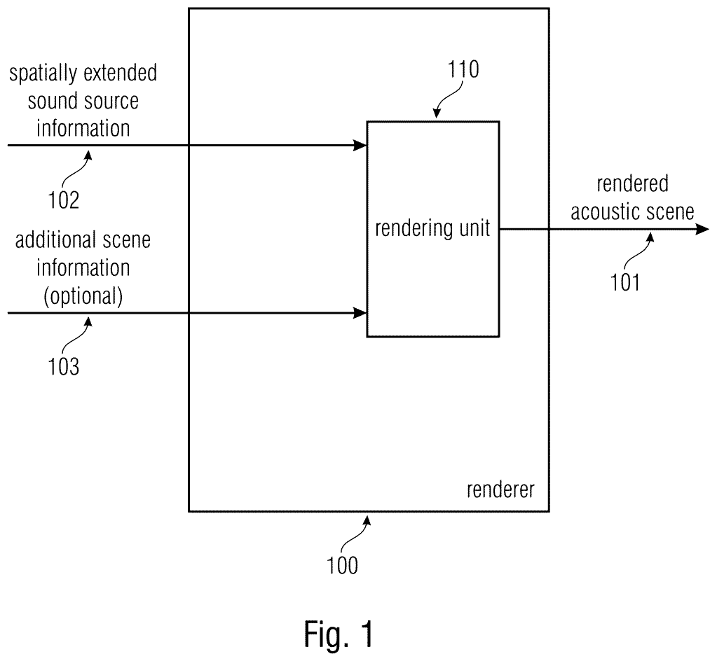

FIG. 1 shows a schematic view of a renderer according to embodiments of the disclosure. FIG. 1 shows renderer 100 for rendering, e.g. spatially rendering, an acoustic scene, comprising a rendering unit 110. Accordingly, renderer 100 may provide a rendered, e.g. spatially rendered, acoustic scene 101.

Renderer 100 is configured to render, e.g. using rendering unit 110, an acoustic impact of a diffuse sound which originates in a first spatial region in a second spatial region using a spatially extended sound source. Therefore, renderer 100 is provided with a spatially extended sound source information 102.

Optionally, spatially extended sound source information 102 may, for example, comprise a full set of parameters defining the SESS, or for example, only some parameters, e.g. geometric information (e.g. geometric portal information corresponding to geometric SESS information, e.g. location information, e.g. sound level information) which may be complemented or extended using processing results of the renderer and or a corresponding decoder comprising the renderer.

As an optional feature, an additional scene information 103 is shown, which may be an information based on which the rendered acoustic scene 101 is to be provided (whilst taking into account or consideration the diffuse-sound acoustic impact), hence, for example comprising an information about spectral values or time domain audio information and/or metadata information about the acoustic scene that is to rendered.

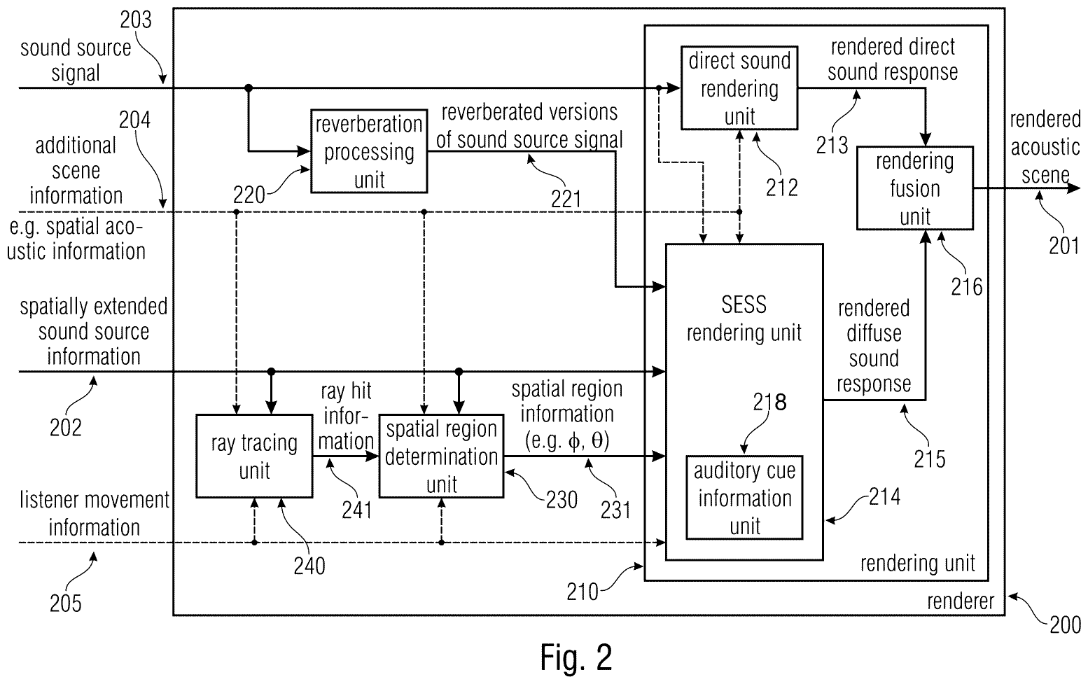

FIG. 2 shows a schematic view of a renderer with additional optional features, according to embodiments of the disclosure.

FIG. 2 shows renderer 200 comprising a rendering unit 210, wherein the rendering unit 210 comprises, as optional features, a direct sound rendering unit 212, a SESS rendering unit 214 and a rendering fusion unit 216.

As explained in the context of FIG. 1 the renderer 200 is configured to render, using rendering unit 210, an acoustic impact of a diffuse sound which originates in a first spatial region in a second spatial region, using a spatially extended sound source. Hence, rendering unit 210 is configured to provide a rendered acoustic scene 201. As an optional feature, the optional rendering fusion unit is configured to provide the rendered acoustic scene 201.

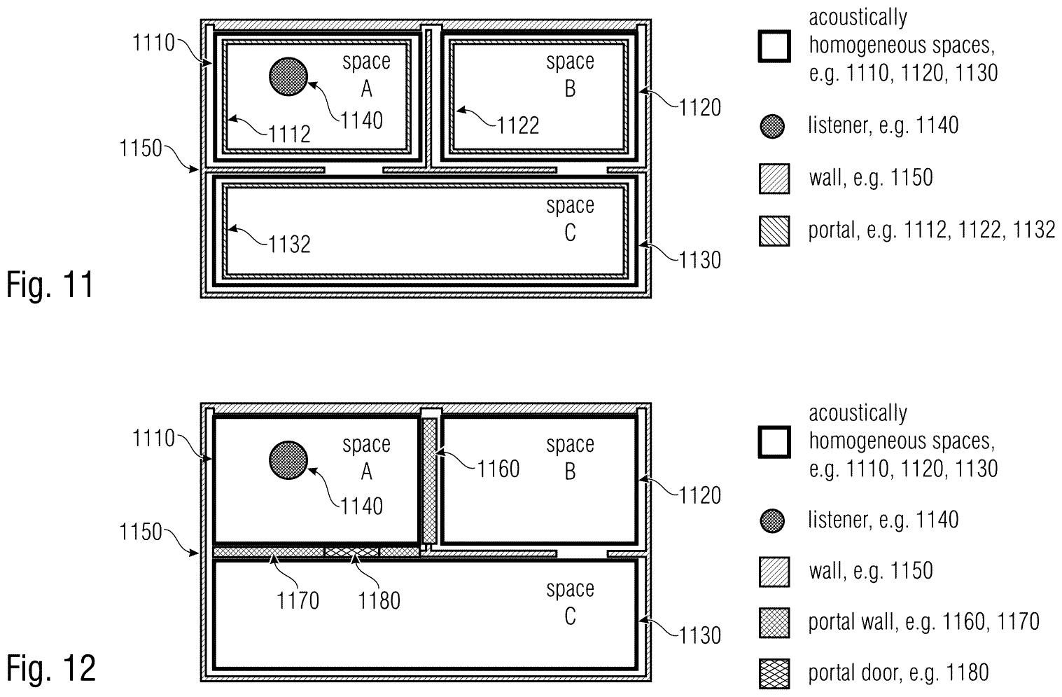

Therefore, as an optional feature, in order to render the acoustic impact of the diffuse sound, the SESS rendering unit 214 is provided with a spatially extended sound source information 202 (e.g. in accord with its counterpart 102 in FIG. 1), which may for example, comprise an information about a portal, e.g. a portal according to method 1 or method 2 as explained with regard to FIGS. 11 and 12, and/or an absolute position information and/or a relative position information with respect to a listener. Optionally, spatially extended sound source information 202 may comprise any information suitable in order to define a spatially extended sound source in order to provide the rendered diffuse sound response.

As an optional feature, the direct sound rendering unit 212 is configured to render a direct-sound acoustic impact of a given sound source, which is located in the first spatial region, in the second spatial region using a direct-sound rendering. Furthermore, as another optional feature, the SESS rendering unit 214 is configured to render a diffuse-sound acoustic impact of the given sound source in the second spatial region using the spatially extended sound source.

Therefore, as an optional feature, direct sound rendering unit 212 is provided with a sound source signal 203 of the given sound source, to which a direct source rendering is applied in order to obtain a rendered direct sound source response 213 at a listener position which is located in the second spatial region. As another optional feature, SESS rendering unit 214 may as well be provided with signal 203.

As another optional feature and as shown in FIG. 2, the SESS rendering unit 214 is provided with one or more reverberated versions 221 of the sound source signal of the given sound source. Furthermore, the SESS rendering unit 214 is configured to apply a spatially extended sound source rendering to the one or more reverberated versions 221 of the sound source signal of the given sound source, in order to obtain a rendered diffuse sound response 215 at the listener position which is located in the second spatial region.

For a provision of the one or more reverberated versions of the sound source signal 221, the renderer comprises, as an optional feature, a reverberation processing unit 220, which is configured to provide the one or more reverberated versions of the sound source signal 221 bases on the sound source signal 203.

In other words, the reverberation processing unit 220 is configured to apply a reverberation processing to the sound source signal 203 of the given sound source, in order to obtain one or more reverberated versions of the sound source signal 221 of the given sound source.

As an optional feature, the rendering fusion unit is configured to fuse the rendered direct sound response 213 and the rendered diffuse sound response 215 in order to obtain the rendered acoustic scene 201.

Hence, as an example, based on a sound source signal 203, the renderer may be configured to determine a diffuse version, in the form of a reverberated version of the sound source signal, based on which a diffuse sound response may be provided efficiently and authentically for a listener.

As another optional feature, the SESS rendering unit 214 is configured to render an acoustic impact of a late reverberation, which is excited by a sound source located in the first spatial region in the second spatial region using the spatially extended sound source that reproduces the late reverberation.

In other words and as an example, based on the spatially extended sound source information 202, the SESS rendering unit 214 may render a spatially extended sound source in order to represent an influence of a late reverberation of the sound source.

As another optional feature, the spatially extended sound source, e.g. as defined by spatially extended sound source information 202, may have a similar spectral content in each spatial region. As an example, the inventors recognized that a SESS with uniformly distributed spatial frequency distribution may be used in order to represent a diffuse sound field impact efficiently.

As another optional feature, for example based on an information about a portal included in the spatially extended sound source information 202, the SESS rendering unit 214 is configured to render the acoustic impact of the diffuse sound using a spatially extended sound source which is placed at a portal between the first spatial region and the second spatial region and which reproduces the diffuse sound which originates from the first spatial region.

As another optional feature, the renderer 200 is configured to render, e.g. using SESS rendering unit 214, the acoustic impact of the diffuse sound using a spatially extended sound source, which takes a geometric extent of the first spatial region and which reproduces the diffuse sound which originates from the first spatial region, taking into consideration an occlusion of the spatially extended sound source at a listener position located within the second spatial region.

Therefore, as an optional example, additional scene information 204, for example comprising spatial acoustic information, e.g. information about walls, openings, doors, materials, may be provided to the SESS rendering unit 214 and optionally to direct sound rendering unit 212.

Based on such an information, the SESS rendering unit 214 may be configured to determine occlusion effects in order to authentically render the acoustic scene.

As another optional feature, the renderer 200 is configured to determine in which spatial region relative to a listener's position and/or a listener's orientation the spatially extended sound source for the reproduction of the diffuse sound lies and/or is occluded, and to render the spatially extended sound source in dependence thereon.

Therefore, renderer 200 comprises a spatial region determination unit 230, which is provided with the spatially extended sound source information 202 and optionally with the additional scene information 204, and which is configured to provide a spatial region information 231, e.g. an azimuth and elevation, e.g. ¢, 0, with respect to a listener and/or a listener centered coordinate system, identifying a relative location of listener and the spatially extended sound source.

Accordingly spatial region information 231 is, as an optional feature, provided to SESS rendering unit 214, for an evaluation thereof and in order to incorporate the information about the relative position and/or occlusion in the rendering procedure.

As another optional feature, the renderer 200 is configured to determine the spatial region information 231 using a ray-tracing based approach. Therefore, renderer 200 comprises, as an optional feature, a ray tracing unit 240. As optionally shown, ray tracing unit 240 may be provided with the spatially extended sound source information 202 and with the optional additional scene information 204. Based thereon, a ray hit information 241 may be determined and provided to spatial region determination unit 230. The ray tracing unit may be configured to determine, based on a simulation of a plurality of rays in a three-dimensional acoustic scene (e.g. the scene to be rendered), a two-dimensional approximation of acoustically relevant objects and/or characteristics from the point of view of a listener. Hence, based on an information about rays hitting modeled entities, such as the spatially extended sound source and/or objects, an information about a relative position between listener and spatially extended sound field and/or occlusion effects (e.g. based on occluding objects that were hit by a ray) to be considered may be obtained.

As another optional feature, the renderer is configured to determine, e.g. using ray tracing unit 240, for a plurality of areas whether a ray associated with a respective area and extending away from a listener's position hits the spatially extended sound source to thereby determine in which spatial region relative to a listener's position and/or a listener's orientation the spatially extended sound source for the reproduction of the diffuse sound lies.

As another optional feature, the SESS rendering unit 214 comprises an auditory cue information unit 218.

Hence, optionally, the renderer is configured to determine, e.g. using auditory cue information unit 218 one or more auditory cue information items in dependence on the spatial region in which the spatially extended sound source for the reproduction of the diffuse sound lies to process, e.g. using SESS rendering unit 214, one or more audio signals representing the diffuse sound using the one or more auditory cue information items, in order to obtain a rendered version of the diffuse sound, e.g. in the form of the rendered diffuse sound response.

Auditory cue information items may, for example, comprise and information about at least one of Inter-Channel Coherence (ICC), Inter-Channel Phase Differences (ICPD) and/or Inter-Channel Level Differences (ICLD). Such information entities may allow to adapt a binaural rendering in a way to provide a listener with an authentic hearing experience, e.g. for binaural rendering.

As another optional feature, the renderer 200 is configured to update the determination, in which spatial region relative to a listener's position and/or a listener's orientation, the spatially extended sound source for the reproduction of the diffuse sound lies, in response to a movement of the listener.

Alternatively or in addition, the renderer 200 is configured to update the determination of the one or more auditory cue information items in response to a movement of the listener.

Alternatively or in addition, the renderer is configured to update the determination of the one or more cue information items in response to a change of the spatial region in which the spatially extended sound source for the reproduction of the diffuse sound lies.

Therefore, as an optional feature, the spatial region determination unit 230, the ray tracing unit 240 and the auditory cue information unit 218 are provided with an optional listener movement information 205 (e.g. comprising a listener position information), which may trigger such an updates.

In the following, a further example for embodiments according to FIG. 2 is discussed in simple words. As an example, a sound source signal 203 comprising spectral values and/or time domain samples of an audio signal of a sound source to be rendered may be provided to the renderer 200. A listener, for which the sound source is to be represented, may be located in a different spatial region, e.g. room, than the source. Hence, for an authentic representation of the hearing impression, renderer 200 comprises a direct sound rendering unit 212 and a SESS rendering unit 214, wherein the first takes a direct sound response and the latter takes a diffuse sound impact, for the listener, from the sound source, into account. The inventors recognized that a diffuse sound impact, e.g. as caused by a vibrating side wall of the listener's room in between the listener's room and the room of the sound source may be represented efficiently using a SESS. Optionally, the diffuse sound impression of the sound signal may be approximated based on a reverberation processing. Furthermore, such a SESS may, for example, advantageously be placed at the position of the vibrating side wall between the rooms, relative to a position of the listener. Therefore, an information about the spatial characteristics of the audio scene to be rendered may be provided to the renderer, e.g. as additional scene information 204. Based thereon, and for example, a geometric and/or position information of the SESS included in the SESS information 202 and/or a listener information 205 (e.g. comprising a position of the listener), e.g. using a ray tracing approach, a spatial region information may be determined. Based on such an information the renderer may accurately ‘place’ listener, SESS (e.g. representing vibrating side wall) and/or further obscuring or attenuating objects in a correct constellation and render, based thereon, the scene realistically for the listener.

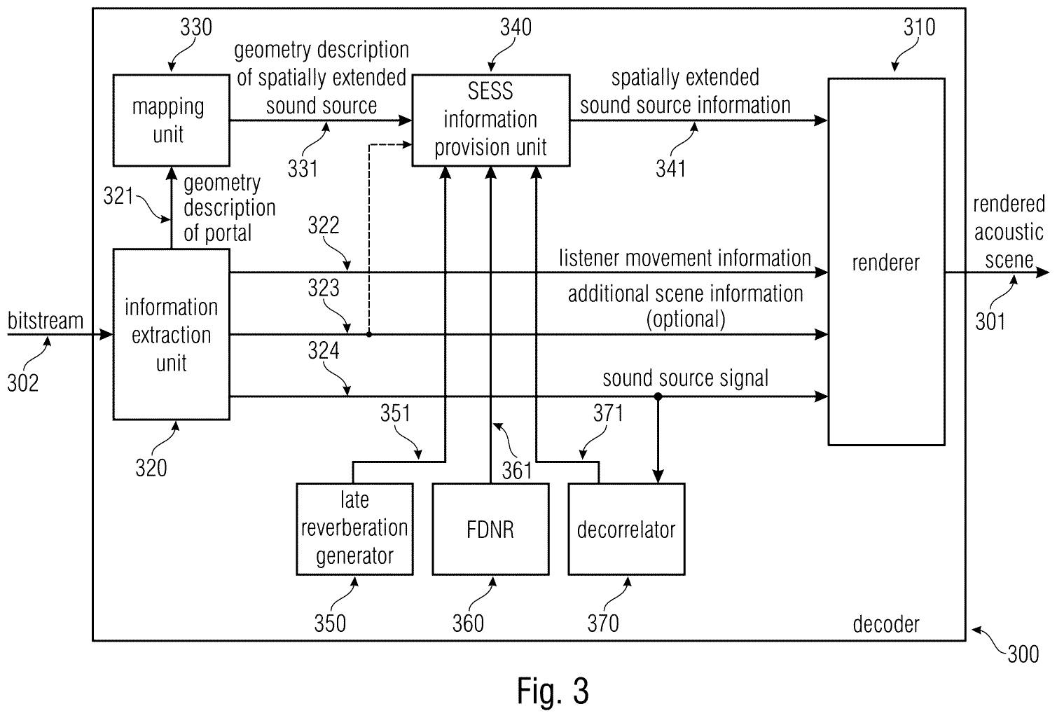

FIG. 3 shows a schematic view of a decoder according to embodiments of the disclosure. FIG. 3 shows decoder 300 comprising a renderer 310, e.g. according to renderer 200 from FIG. 2 or renderer 100 from FIG. 1 or according to any renderer configuration as disclosed herein. Accordingly, renderer 310 is configured to provide a rendered acoustic scene 301.

Decoder 300 is configured to obtain a geometry description of a portal 321 from a bitstream 302 and to map the geometry of the portal onto a listener-centered coordinate system, in order to obtain a geometry description of the spatially extended sound source 331 for the reproduction of the diffuse sound.

Therefore, as an optional feature, decoder 300 comprises an information extraction unit 320, which is configured to extract the geometry description of the portal from the bitstream 302. As further, optional, features, a listener movement information 322, an additional scene information 323 and/or a sound source signal 324 may be additionally extracted from the bitstream 302. As optionally shown, these information entities may be provided to the renderer 310 and may be processed, e.g. as explained in the context of FIG. 2.

For the mapping to the listener-centered coordinate system, decoder 300 comprises, as an optional feature, a mapping unit 330, which is configured to provide the geometry description 331 of the spatially extended sound source to a SESS information provision unit 340.

The SESS information provision unit 340 is configured to provide the spatially extended sound source information 341 to the renderer 310. The spatially extended sound source information 341 may, for example, comprise a geometry information (e.g. about the SESS and/or audio signal information, e.g. a representation of an audio signal).

As another optional feature, the audio decoder is configured to obtain two or more signals 351, which are at least partially decorrelated, for the rendering of the spatially extended sound source derived from the output of a late reverb generator. Therefore, audio decoder 300 comprises, as an optional feature, a late reverberation generator 350. As shown, the two or more signals may be provided, from the late reverberation generator 350, to the SESS information provision unit 340 and may be included in the spatially extended sound source information 341.

As another optional feature, the audio decoder 300 is configured to obtain two or more signals 361 for the rendering of the spatially extended sound source using a feedback delay network reverberator (FDNR) 360. Therefore, decoder 300 comprises, as an optional feature, a FDNR 360. As shown, the two or more signals may be provided from the FDNR 360, to the SESS information provision unit 340 and may be included in the spatially extended sound source information 341.

As another optional feature, the decoder 300 is configured to use the sound source signal and a decorrelated version of the sound source signal for the rendering of the spatially extended sound source. Therefore, decoder 300 comprises, as an optional feature, a decorrelator 370 which is provided with the sound source signal 324. As shown, the two signals 371 may be provided from the decorrelator 370, to the SESS information provision unit 340 and may be included in the spatially extended sound source information 341.

It is to be noted that the three approaches, e.g. using late reverberation generator 350, FDNR 360 and/or decorrelator 370 may, for example, be used as alternatives.

Based on these signals, and for example optionally, auditory cue information items, SESS information may be obtained, e.g. in SESS information provision unit 340. Such auditory cue information items may, for example, be included in additional scene information 323, which may be provided to the unit 340.

As another optional feature, the decoder 300 is configured to exclude or attenuate occluded spatial regions when rendering the spatially extended sound source. As an optional feature, therefore, SESS information provision unit 340 is provided with the additional scene information 323, which may comprise spatial acoustic scene information, such that SESS information provision unit may be configured to provide an information for excluding or attenuating occluded spatial regions in the spatially extended sound source information 341.

Hence, the decoder 300 may be configured to allow for a smooth transition in-and-out of and in-between multiple spatial regions.

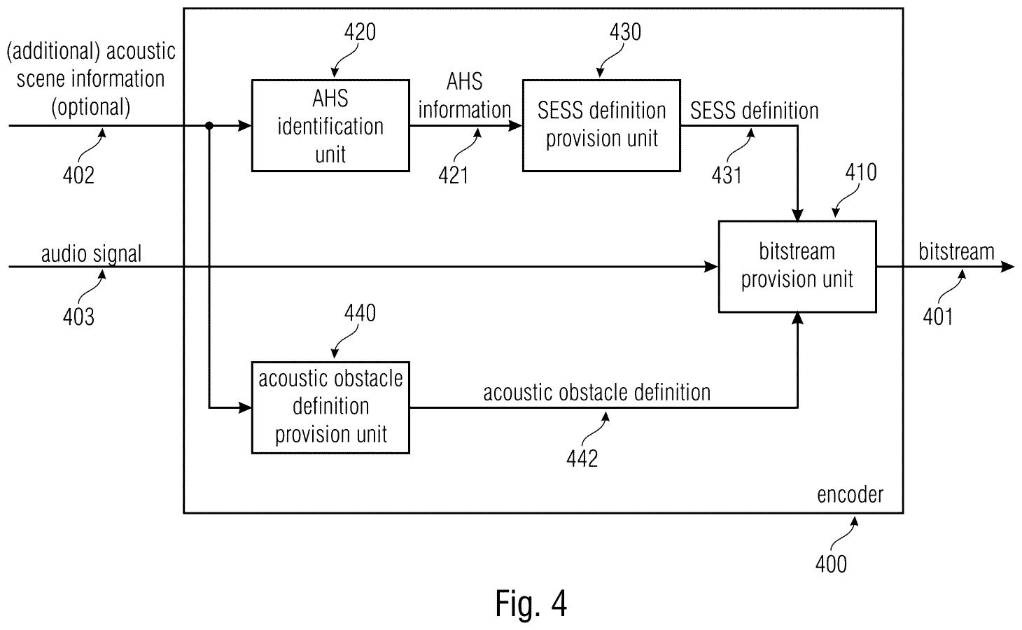

FIG. 4 shows a schematic view of an encoder according to embodiments of the disclosure. FIG. 4 shows encoder 400 for encoding an audio scene, wherein the audio encoder is configured to provide an encoded representation of one or more audio signals.

Therefore, as an optional feature, encoder 400 comprises a bitstream provision unit 410, which is configured to provide a bitstream 401, comprising the encoded representation of one or more audio signals 403.

Furthermore, the audio encoder 400 is configured to identify a plurality of acoustically homogenous spaces (AHS), and to provide definitions of spatially extended sound sources on the basis thereof, wherein geometrical characteristics of the spatially extended sound sources are identical to geometrical characteristics of the identified acoustically homogenous spaces.

Therefore, as an optional feature, encoder 400 comprises an AHS identification unit 420 which is provided with (e.g. additional) acoustic scene information 402, and an optional SESS definition provision unit 430, which is provided with an AHS information 421 from unit 420.

Based thereon, as an optional feature, SESS definition provision unit 430 is configured to provide a SESS definition 431 to the bitstream provision unit, in order to provide said definitions in the bitstream.

The SESS definition 431 may comprise geometric information about a SESS to be used for a rendering.

As another optional feature, the audio encoder 400 is configured to provide definitions 442 of acoustic obstacles between the acoustically homogenous spaces. Therefore, as an optional feature, encoder 400 comprises an acoustic obstacle definition provision unit 440, which is optionally provided with acoustic scene information 402 and which provides the acoustic obstacle definitions 442 to bitstream provision unit 410, which may optionally incorporate said information in bitstream 401.

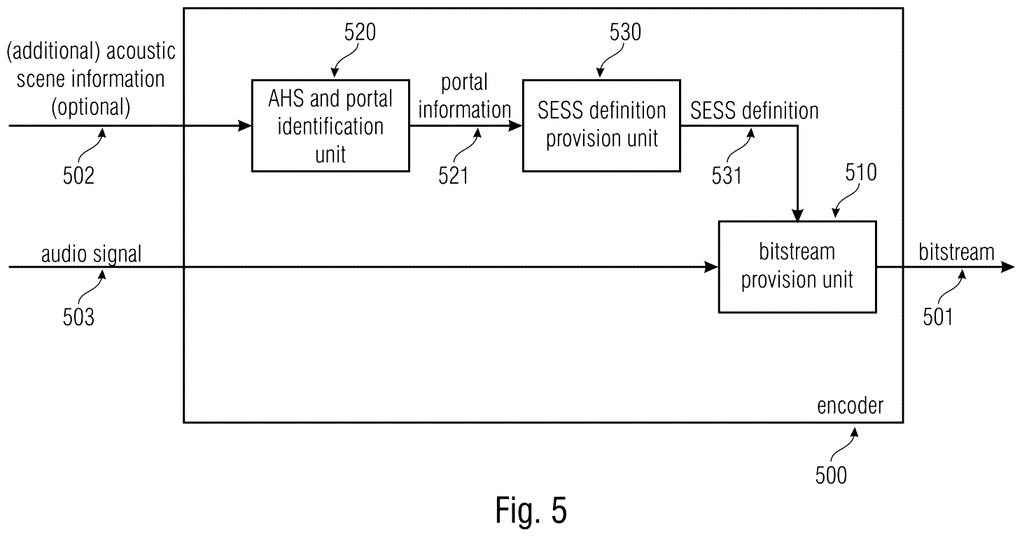

FIG. 5 shows a schematic view of an encoder according to further embodiments of the disclosure. FIG. 5 shows encoder 500 for encoding an audio scene, wherein the audio encoder is configured to provide an encoded representation of one or more audio signals.

Therefore, as an optional feature, encoder 500 comprises a bitstream provision unit 510, which is configured to provide a bitstream 501, comprising the encoded representation of one or more audio signals 503.

Furthermore, encoder 500 is configured to provide definitions 531 of one or more spatially extended sound sources, wherein geometrical characteristics of the spatially extended sound sources are based on geometrical characteristics of portals between acoustically homogenous spaces.

Therefore, as an optional feature, encoder 500 comprises an AHS and portal identification unit 520, which is optionally provided with, optionally additional, acoustic scene information 502. The AHS and portal identification unit 520 is optionally configured to identify AHS in order to identify portals between the AHS, and to provide a portal information 521. The portal information 521 comprises an information about the geometrical characteristics of the portals between the acoustically homogenous spaces.

Furthermore, as an optional feature, and as explained before, encoder 500 comprises a SESS definition provision unit 530, which is provided with the portal information, in order to provide the definitions 531. As optionally shown, these definitions 531 may be provided to the bitstream provision unit 510 to be incorporated into bitstream 501.

Hence, in other words, optionally, the audio encoder 500 is configured to identify a plurality of acoustically homogenous spaces and one or more portals between the acoustically homogenous spaces, and to provide definitions of one or more spatially extended sound sources on the basis thereof, wherein geometrical characteristics of the one or more spatially extended sound sources are based on dimensions of the identified portals.

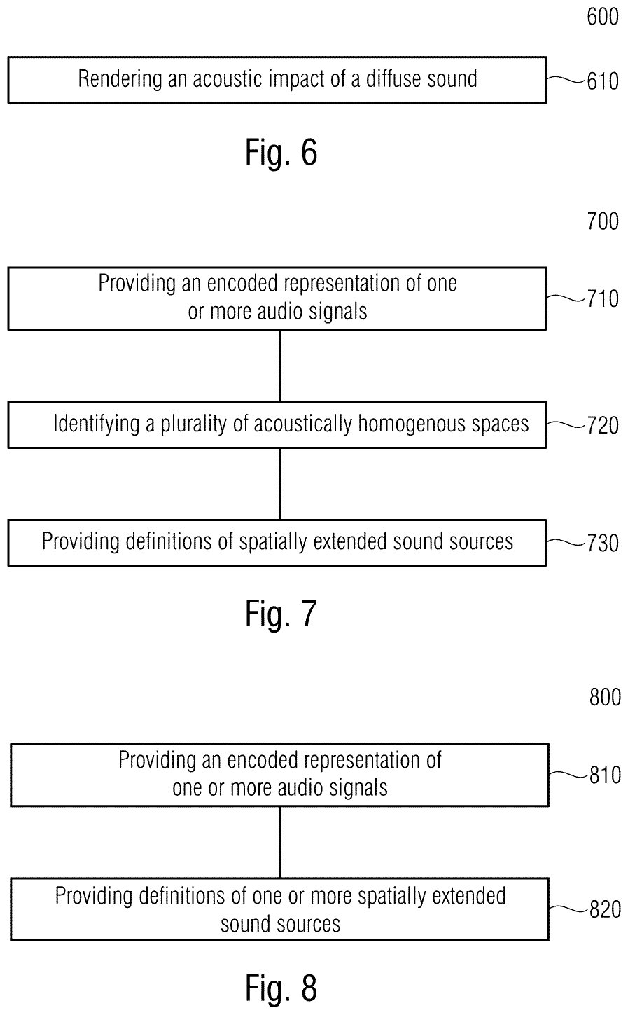

FIG. 6 shows a schematic block diagram of a method for rendering an acoustic scene according to embodiments of the disclosure. The method 600 comprises rendering 610 an acoustic impact of a diffuse sound, which originates in a first spatial region, in a second spatial region, using a spatially extended sound source.

FIG. 7 shows a schematic block diagram of a method for encoding an audio scene according to embodiments of the disclosure. The method 700 comprises providing 710 an encoded representation of one or more audio signals, identifying 720 a plurality of acoustically homogenous spaces and providing 730 definitions of spatially extended sound sources on the basis thereof, wherein geometrical characteristics of the spatially extended sound sources are identical to geometrical characteristics of the identified acoustically homogenous spaces.

FIG. 8 shows a schematic block diagram of a method for encoding an audio scene according to embodiments of the disclosure. The method 800 comprises providing 810 an encoded representation of one or more audio signals and providing 820 definitions of one or more spatially extended sound sources, wherein geometrical characteristics of the spatially extended sound sources are based on geometrical characteristics of portals between acoustically homogenous spaces.

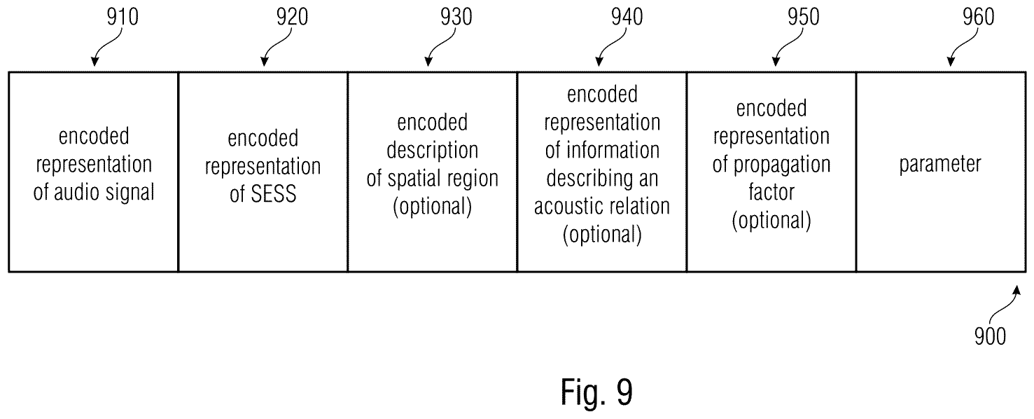

FIG. 9 shows a schematic block diagram of a bitstream according to embodiments of the disclosure. Bitstream 900 comprises an encoded representation 910 of one or more audio signals and an encoded representation 920 of one or more spatially extended sound sources for rendering an acoustic impact of a diffuse sound, which originates in a first spatial region, and is rendered in a second spatial region.

As an optional feature, bitstream 900 comprises an encoded description 930 of one or more spatial regions and an encoded representation 940 of an information describing an acoustic relation between at least two spatial regions.

Optionally, encoded representation may additionally comprise, an encoded representation of one or more audio signals or audio channels representing audio sources that are located in one or more of the spatial regions.

Optionally, the encoded representation of spatial regions comprises a description of a portal between two spatial regions.

As another optional feature, the audio bitstream 900 comprises an encoded representation 950 of a propagation factor describing an acoustic propagation from the first spatial region to the second acoustic region.

Optionally, the propagation factor may describe the amount/fraction of acoustic energy of a first spatial region is radiated into a second spatial region and/or a ratio between a connected surface area between a first space and a second space and an entire absorption surface area of the first space.

As another optional feature, the audio bitstream 900 comprises a parameter 960 describing a range of a transition zone between two spatial regions

### Remarks:

In the following, different inventive embodiments and aspects will be described or further described, e.g. in a section “Overview-Summary”, in a chapter “Objective of Embodiments according to the Disclosure”, in a chapter “Description of Disclosure” and in a chapter “Aspects of the Disclosure”.

Also, further embodiments will be defined by the enclosed claims.

It should be noted that any embodiments as defined by the claims or the above description can optionally be supplemented by any of the details (features and functionalities) described in the above mentioned chapters.

Also, the embodiments described in the above mentioned chapters can be used individually, and can also be supplemented by any of the features in another chapter, by any of the features in another section of the above description, and/or by any feature included in the claims.

Also, it should be noted that individual aspects described herein can be used individually or in combination. Thus, details can be added to each of said individual aspects without adding details to another one of said aspects.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can optionally be supplemented by any of the features and functionalities and details described with respect to the apparatuses.

Also, any of the features and functionalities described herein can be implemented in hardware or in software, or using a combination of hardware and software, as will be described in the section “implementation alternatives”.

Moreover, it should be noted that the audio bitstream [or, equivalently, encoded audio representation] may optionally be supplemented by any of the features, functionalities and details disclosed herein, both individually and taken in combination.

### Implementation Alternatives:

In general, although some aspects are described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the disclosure can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the disclosure comprises a data carrier having electronically readable control signals, which are capable of cooperating with a programmable computer system, such that one of the methods described herein is performed.

Generally, embodiments of the present disclosure can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the disclosure comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this disclosure has been described in terms of several embodiments, there are alterations, permutations, and equivalents which fall within the scope of this disclosure. It should also be noted that there are many alternative ways of implementing the methods and compositions of the present disclosure. It is therefore intended that the following appended claims be interpreted as including all such alterations, permutations and equivalents as fall within the true spirit and scope of the present disclosure.

In the following a section comprising an ‘Overview-Summary’ of embodiments is provided.

According to an aspect, a computationally efficient approach to segment a huge and complicated sound scene and render several realistic diffuse sound fields based on their topological relationship is described. This is, for example, done by modeling an acoustic space with similar diffuse sound characteristic as a homogeneous extended sound source, and then, for example, simply simulating its sound propagation depending on the range of it and its distance from the listener in real time.

Previous researches have proposed ideas like pre-rendered geometry-based method (cannot handle real time source movement and is computationally heavy) or reverberation graph approach (accumulated impulse response as just point source).

According to an aspect, this proposal (e.g. the inventive proposal) utilizes an existing homogeneous extended sound source algorithm to achieve both efficiency and quality.

The following section may provide context for a better understanding of embodiments according to the disclosure.

In the following, some background information will be provided, However, it should be noted that any of the features, functionalities and details disclosed here may optionally be used in embodiments according to the disclosure, both individually and taken in combination. Moreover, reference is also made to PCT/EP2021/050588, which describes an apparatus and a method for reproducing a spatially extended sound source or an apparatus and a method for generating a description for a spatially extended sound source using anchoring information

According to an aspect, the present disclosure relates to audio signal processing and particularly to the encoding or decoding or reproducing of the diffuse sound in an audio scene as spatially extended sound source (SESS).

The reproduction of sound sources over several loudspeakers or headphones has been long investigated. The simplest way of reproducing sound sources over such setups is to render them as point sources, i.e., very (ideally: infinitely) small sound sources. It has been found that this theoretic concept, however, is hardly able to model existing physical sound sources in a realistic way. For instance, a grand piano has a large vibrating wooden closure with many spatially distributed strings inside and thus appears much larger in auditory perception than a point source (especially when the listener (and the microphones) are close to the grand piano. It has been recognized that many real-world sound sources have a considerable size (“spatial extent”) like musical instruments, machines, an orchestra or choir or ambient sounds (sound of a waterfall).

Correct/realistic reproduction of such sound sources has become the target of many sound reproduction methods, be it binaural (i.e., using so-called Head-Related Transfer Functions HRTFs or Binaural Room Impulse Responses BRIRs) using headphones or conventionally using loudspeaker setups ranging, for example, from 2 speakers (“stereo”) to many speakers arranged in a horizontal plane (“Surround Sound”) and many speakers surrounding the listener in all three dimensions (“3D Audio”).

According to an aspect, it is an object of the present disclosure to provide a concept for encoding or reproducing a Spatially Extended Sound Sources with a possibly complex geometric shape.

The following section may be titled ‘2D Source Width’.

This section describes, as examples, methods that pertain to rendering extended sound sources on a 2D surface faced from the point of view of a listener, e.g., in a certain azimuth range at zero degrees of elevation (like is the case in conventional stereo/surround sound) or certain ranges of azimuth and elevation (like is the case in 3D Audio or virtual reality with 3 degrees of freedom [“3DoF”] of the user movement, i.e., head rotation in pitch/yaw/roll axes).

Increasing the apparent width of an audio object which is panned between two or more loudspeakers (generating a so-called phantom image or phantom source) can be achieved by decreasing the correlation of the participating channel signals (Blauert, 2001, S. 241-257). With decreasing correlation, the phantom source's spread increases until, for correlation values close to zero (and not too wide opening angles), it covers the whole range between the loudspeakers.

Decorrelated versions of a source signal are, for example, obtained by deriving and applying suitable decorrelation filters. For example, Lauridsen (Lauridsen, 1954) proposed to add/subtract a time delayed and scaled version of the source signal to itself in order to obtain two decorrelated versions of the signal. More complex approaches were for example proposed by Kendall (Kendall, 1995). He iteratively derived paired decorrelation all-pass filters based on combinations of random number sequences. Faller et al. Propose, for example, suitable decorrelation filters (“diffusers”) in (Baumgarte & Faller, 2003) (Faller & Baumgarte, 2003). Also Zotter et al. derived, for example, filter pairs in which frequency-dependent phase or amplitude differences were used to achieve widening of a phantom source (Zotter & Frank, 2013). Furthermore, for example, (Alary, Politis, & Välimäki, 2017) proposed decorrelation filters based on velvet noise which were, for example, further optimized by (Schlecht, Alary, Välimäki, & Habets, 2018).

Besides reducing correlation of the phantom source's corresponding channel signals, source width can, for example, also be increased by increasing the number of phantom sources attributed to an audio object. In (Pulkki, 1999), for example, the source width is controlled by panning the same source signal to (slightly) different directions. The method was originally proposed to stabilize the perceived phantom source spread of VBAP-panned (Pulkki, 1997) source signals when they are moved in the sound scene. This is, for example, advantageous since dependent on a source's direction, a rendered source is reproduced by two or more speakers which can result in undesired alterations of perceived source width.

For example, Virtual world DirAC (Pulkki, Laitinen, & Erkut, 2009) is an extension of the traditional Directional Audio Coding (DirAC) (Pulkki, 2007) approach for sound synthesis in virtual worlds. For rendering spatial extent, directional sound components of a source are, for example, randomly panned within a certain range around the source's original direction, where panning directions vary, for example, with time and frequency.

A similar approach is, for example, pursued in (Pihlajamäki, Santala, & Pulkki, 2014), where spatial extent is achieved by randomly distributing frequency bands of a source signal into different spatial directions. This is a method aiming, for example, at producing a spatially distributed and enveloping sound coming equally from all directions rather than controlling an exact degree of extent.

For example, Verron et al. achieved spatial extent of a source by not using panned correlated signals, but by synthesizing multiple incoherent versions of the source signal, distributing them uniformly on a circle around the listener, and mixing between them (Verron, Aramaki, Kronland-Martinet, & Pallone, 2010). The number and gain of simultaneously active sources determine, for example, the intensity of the widening effect. This method was, for example, implemented as a spatial extension to a synthesizer for environmental sounds.

The following may be titled ‘3D Source Width’.

This section describes, for example, methods that pertain to rendering extended sound sources in 3D space, i.e. in a volumetric way as it is, for example, used (or at least advantageous) for virtual reality with 6 degrees of freedom (“6DoF”). This means, for example, 6 degrees of freedom of the user movement, i.e. head rotation in pitch/yaw/roll axes) plus 3 translational movement directions x/y/z.

For example, Potard et al. extended the notion of source extent as a one-dimensional parameter of the source (i.e., its width between two loudspeakers) by studying the perception of source shapes (Potard, 2003). They generated, for example, multiple incoherent point sources by applying (time-varying) decorrelation techniques to the original source signal and then, for example, placing the incoherent sources to different spatial locations and by this giving them three-dimensional extent (Potard & Burnett, 2004).

For example, in MPEG-4 Advanced AudioBIFS (Schmidt & Schröder, 2004), volumetric objects/shapes (shuck, box, ellipsoid and cylinder) can be filled with several equally distributed and decorrelated sound sources to evoke three-dimensional source extent.

In order to increase and control source extent using Ambisonics, Schmele at al. (Schmele & Sayin, 2018) proposed, for example, a mixture of reducing the Ambisonics order of an input signal, which inherently increases the apparent source width, and distributing decorrelated copies of the source signal around the listening space.

Another approach was, for example, introduced by Zotter et al., where they adopted the principle proposed in (Zotter & Frank, 2013) (i.e., deriving filter pairs that introduce, for example, frequency-dependent phase and magnitude differences to achieve source extent in stereo reproduction setups) for Ambisonics (Zotter F., Frank, Kronlachner, & Choi, 2014).

For example, a common disadvantage of panning-based approaches (e.g., (Pulkki, 1997) (Pulkki, 1999) (Pulkki, 2007) (Pulkki, Laitinen, & Erkut, 2009)) is their dependency on the listener's position. Even a small deviation from the sweet spot causes the spatial image to collapse into the loudspeaker closest to the listener. This drastically limits their application in the context of virtual reality and augmented reality with 6 degrees-of-freedom (6DoF) where the listener is supposed to freely move around. Additionally, distributing time-frequency bins in DirAC-based approaches (e.g., (Pulkki, 2007) (Pulkki, Laitinen, & Erkut, 2009)) not always guarantees the proper rendering of the spatial extent of phantom sources. Moreover, it typically significantly degrades the source signal's timbre.

Decorrelation of source signals is, for example, usually achieved by one of the following methods: i) deriving filter pairs with complementary magnitude (e.g. (Lauridsen, 1954)), ii) using all-pass filters with constant magnitude but (randomly) scrambled phase (e.g., (Kendall, 1995) (Potard & Burnett, 2004)), or iii) spatially randomly distributing time-frequency bins of the source signal (e.g., (Pihlajamäki, Santala, & Pulkki, 2014)).

All approaches come with their own implications: Complementary filtering a source signal according to i) typically leads to an altered perceived timbre of the decorrelated signals. While all-pass filtering as in ii) preserves the source signal's timbre, the scrambled phase disrupts the original phase relations and especially for transient signals causes severe temporal dispersion and smearing artifacts. Spatially distributing time-frequency bins proved to be effective for some signals, but also alters the signal's perceived timbre. Furthermore, it showed to be highly signal dependent and introduces severe artifacts for impulsive signals.

For example, populating volumetric shapes with multiple decorrelated versions of a source signal as proposed in Advanced AudioBIFS ((Schmidt & Schröder, 2004) (Potard, 2003) (Potard & Burnett, 2004)) assumes availability of a large number of filters that produce mutually decorrelated output signals (typically, more than ten point sources per volumetric shape are used). However, finding such filters is not a trivial task and becomes more difficult the more such filters are needed. Furthermore, if the source signals are not fully decorrelated and a listener moves around such a shape, e.g., in a (virtual reality) scenario, the individual source distances to the listener correspond to different delays of the source signals and their superposition at the listener's ears result, for example, in position dependent comb-filtering potentially introducing annoying unsteady coloration of the source signal.

For example, controlling source width with the Ambisonics-based technique in (Schmele & Sayin, 2018) by lowering Ambisonics order showed to have an audible effect only for transitions from 2nd to 1st or to 0th order. Furthermore, these transitions are not only perceived as a source widening but also frequently as a movement of the phantom source. While adding decorrelated versions of the source signal could help stabilizing the perception of apparent source width, it also introduces comb-filter effects that alter the phantom source's timbre.

An efficient method for binaural rendering a spatially extended sound source, which can optionally be used in embodiments according to the disclosure, was disclosed in EP3879856 using, for example,
One (mono) input waveform signal
A decorrelator to produce a decorrelated version of this signal (optional)
A cue calculation stage that calculates, for example, the target binaural (and timbral) cues of the spatially extended sound source, for example, depending on the size of the source (e.g. given as an azimuth-elevation angle range depending on the position and orientation of the spatially extended sound source and the listener).
A binaural cue adjustment stage that produces, for example, the binaurally rendered output signal, for example, from the input signal and its decorrelated version using the target cues form the cue calculation stage.

### The Following Section May be Titled ‘Topological Sound Propagation’.

Modeling of sound propagation is important (or even crucial in some cases) for virtual acoustics and virtual reality applications. Specifically, it has been found that the concept of topological sound propagation is, for example, important to model the propagation of sound, for example, between different acoustic rooms with possibly different acoustic properties. An aspect of this disclosure focuses, for example, especially on the in-door reverberation effects resulting from sound scattering off wall surfaces and how to accurately and efficiently model these effects for virtual environments.

Despite the considerable research history of acoustic simulation, most acoustic modeling approaches were mostly focusing on a single acoustic space, such as a concert halls or an auditorium. For complex scenes with numerous rooms and corridors, an accurate simulation entails heavy computation, which is often impossible to achieve in real-time. As a result, a pre-computed simulation is often used. Also, for such environments, it is, for example, advantageous to split the geometric model into separate rooms that are connected to each other by portals. (Vorländer & Schröder, 2007).

For example, Efstathios et. al proposed a reverberation graph approach that first subdivides a complex geometry into a series of coupled spaces which are connected by portals, and then to precompute ‘transport operators’ using off-line geometrical-acoustics techniques and represent them as point sources. In other words, the method traces, for example, the paths of sources to portals, between portals, and from portals to listeners in order to simulate the entire propagation route. (Stavrakis, Tsingos & Calamia, 2009)

For example, another different approach by Tsingos utilizes pre-calculated image sources gradients to generate location dependent reverb in real-time without accessing complex 3D geometry data. (Tsingos, 2009).

These proposals are all feasible to realise real-time topological sound propagation for diffuse sound.

According to an aspect, the inventive method (or apparatus, or concept) puts forward a new technology that improves, for example, on two disadvantages seen in the previous solutions:
1. A pre-computed simulation is only valid for previously known source and listener location (source/listener location combinations) and thus limits the movement of either or both the sources and the listener.
2. The portal is represented as a point source, which is not true in a real world scenario. In other words, the sound that is perceived in one room as having propagated from an adjacent room is located at one specific location (i.e. the location of the portal's point source) rather than coming from the entire opening between the two rooms (wherein, for example, the latter may be the case according to embodiments of the disclosure). This makes the resulting acoustic impression unrealistic, especially when a listener is close to the portal.

### In the Following Chapter an Objective of Embodiments According to the Invention is Discussed

According to an aspect, it is the objective of this invention to provide efficient and realistic rendering of diffuse sound and its topological propagation as portal, for example, using Spatially Extended Sound Sources, for example as they have been described in detail in EP 3879856. The proposed algorithm provides, for example, a unified solution for rendering multiple acoustically homogeneous spaces (AHSs) smoothly, for example, regardless of the sound sources' and listener's position and movement. Specifically, according to an aspect, the disclosure not only addresses realistic and efficient rendering of virtual sound, but, for example, also the need for a bitrate-efficient representation of these sound aspects that can be transmitted from an encoder to a (possibly remote) VR renderer.

### In the Following Chapter ‘Description of Embodiments’ Embodiments of the Disclosure are Described:

An overview of an embodiment of the inventive method is provided hereafter:

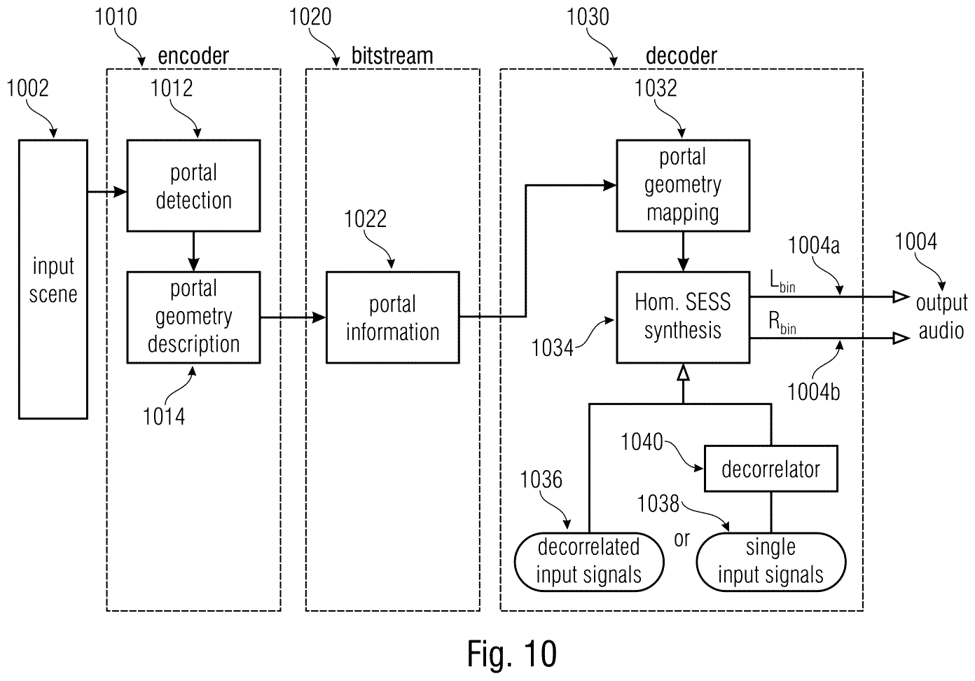

FIG. 10 shows a schematic block diagram of a pipeline of an inventive method. As an example, the block diagram of FIG. 10 may demonstrate an example of the pipeline of an inventive method, wherein encoder, bitstream and decoder can optionally be used as separate embodiments. FIG. 10 illustrates, as an example, the metadata and signal flow of the inventive method (or concept) in three main components: encoder (e.g. 1010), bitstream (e.g. 1020) and decoder (e.g. 1030). For example, at the very beginning of the pipeline, a scene with 3D geometries is provided as an input (e.g. 1002), and, for example, the final output produced (e.g. Output audio 1004) by the decoder is binauralized audio, e.g. comprising left and right binaural signals L_{bin} and R_{bin} (1004a and 1004b). Accordingly it is to be noted that as shown in FIG. 10, a renderer according to embodiments, e.g. included in decoder 1030, may be configured to configured to perform a binaural rendering.

The approach is explained in three consecutive sections corresponding to the three components mentioned above:
1. Encoder (e.g. 1010): (aspect of the disclosure; example; details are all optional)
   For example, for each AHS in the input scene (e.g. 1002), a geometry outlining the extent of it is given. There are possibly (optionally) additional geometries like walls and ceilings as well. Using this information, for example, two different types of methods can be used to detect or create the geometry of portals. The detail of both method and what ‘portal’ represents for each of them are explained below (e.g. taking reference to FIGS. 11 and 12):
      For example, the first method takes the entire geometry of each AHS as the geometry description of its corresponding portal. FIG. 11 shows a schematic overview of an audio scene with three acoustically coupled spatial regions in the form of spaces A, B, and C. In other words, FIG. 11 illustrates an example of which there are three such spaces A, B and C (e.g. 1110, 1120, 1130). FIG. 11 may show an example of the portal detection method 1, for example, according to embodiments wherein a spatially extended sound source may take a geometric extent of the first spatial region. As can be seen in the FIG. 11, a portal (e.g. 1112, 1122, 1132) has, for example, the same geometry (e.g. a same shape, but for example a shrunk area) as its AHS. Furthermore, as shown in this example, the first and/or second spatial region, as explained before, may be acoustically homogenous spaces. A great advantage of this method is that, for example, simply the AHS in which the listener is located can be identified as a portal. This means that, for example, only one algorithm is needed to render all AHSs throughout the whole scene, regardless of where the listener (e.g. 1140) is (for example, compared to the second method). If the listener moves, for example, to Space C, the same three portals still represent their respective AHSs. Occlusion of these radiating portals may need to be taken care of (or, in some cases, has to be taken care of), for example, in a separate occlusion stage which is usually (for example) part of virtual 6DoF auditory environments and beyond the scope of this description, e.g. the description of this paragraph. As explained before, as an example, ray-tracing may be implemented according to embodiments in order to take occlusion effects (e.g. of walls 1150) into account. Furthermore, it is to be noted that as shown in FIG. 11 and in accord with the above explanation, a renderer, e.g. as included in decoder 1030, may be configured to render a plurality of spatially extended sound sources comprising one or more spatially extended sources, which are distant from a listener position (e.g. spatially extended sound sources as represented by or representing portals 1122 and 1132) and one or more spatially extended sources (e.g. spatially extended sound sources as represented by or representing portal 1112), inside of which the listener position is located using a same rendering algorithm, taking into account occlusions between the listener position and the one or more spatially extended sources which are distant from the listener position.
      For example, The second method identifies and utilizes the connected parts between two AHSs to generate the geometry description of portals. The portal serves, for example, as a representation of the adjacent AHS and radiates, for example, its sound with the correct spatial extent into the listener space. For example, an algorithm can be used to analyze the geometrical relationship between all AHSs in the scene and to detect possible portals. An example is given in FIG. 12. FIG. 12 shows a schematic overview of an audio scene with three acoustically coupled spatial regions in the form of spaces A, B, and C, as explained in FIG. 11. However in contrast, FIG. 12 may show an example of the portal detection method 2, for example, according to embodiments wherein a spatially extended sound source is placed at a portal between the first spatial region and the second spatial region. Accordingly, as an optional feature for embodiments of the disclosure, as shown in FIG. 12, the first spatial region and the second spatial region may be rooms which are acoustically coupled via a portal. For example, when the listener (e.g. 1140) is in Space A (e.g. 1110), the wall that is shared by it and Space B is identified as a portal to represent AHS B. [this is, for example, indicated by the orange portal_wall (e.g. 1160) drawn between A (e.g. 1110) and B (e.g. 1120) in FIG. 12] For example, in the case of Space C (e.g. 1130), the connected parts of it and Space A include a section of wall and also the doorway (for example, no geometry, only a region of empty space). This results, for example, in two portals with different radiation properties to represent AHS C. [for example, the orange portal_wall (e.g. 1170) and red portal_door (e.g. 1180) drawn between Spaces A and C in FIG. 12]. This method entails, for example, more geometry processing (or it can also be manually authored by the user directly) but also provides more flexibility in creating a complex sound scene: Type 2 portals can, for example, be interpreted as a medium that enables sound propagation between any pair of AHSs, for example, with or without close relation in the physical space. Namely, this type of portal allows, for example, to author them based on not only actual geometrical relationships but also artistic intent. Thus, they provide, for example, more flexible rendering options.

Hence, portal detection unit 1012 as shown in FIG. 10 may be configured to detect portals corresponding to AHS, e.g. as explained with regard to method 1, or may be configured to detect portals corresponding to interfaces between AHSs, e.g. as explained with regard to method 2. Accordingly, portal geometry description unit 1014 may be configured to determine a respective geometry description of the respective portal, e.g. according to an identical shape like a corresponding AHS (e.g. for method 1), for example with shrunken outer bounds, or e.g. according to intersections between AHSs (e.g. for method 2).

Furthermore, according to some embodiments of the disclosure, SESS and portals may be used interchangeably. Hence, a SESS may be placed at a position of a portal, or a portal may be described or represented or rendered using or by a SESS. Furthermore, according to some embodiments AHS and portals may be used interchangeably at least with regard to some characteristics. Portals may, for example, share a same shape with a corresponding AHS, but, for example, shrunken boundaries.

Optionally, portals may be rendered as or using a SESS. Accordingly portals representing AHS may be rendered as, or using SESS.
2. Bitstream (e.g. 1020): (aspect of the disclosure; example; details are all optional)
   The generated portal geometries (for example, with relevant metadata, if desired) are (optionally) quantized and (optionally) serialized into a bitstream and signaled as portal information (e.g. 1022). This allows, for example, the data to be transmitted efficiently from the encoder (e.g. 1010) to a remote decoder (e.g. 1030).
3. Decoder (e.g. 1030): (aspect of the disclosure; example; details are all optional)
   In the decoder, the geometry description of the portals from the bitstream are, for example, unpacked and reconstructed in a scene. To convert these 3D geometries into usable metadata, for example, for the Hom. SESS Synthesis algorithm, for example, in real-time, for example, a process is carried out that maps the geometry onto a listener-centered coordinate system and finds which spatial regions this geometry occupies (for example, from the listener's point of view, e.g. using a mapping unit 1032).
   For example, an advantageous implementation of the inventive method uses a ray-tracing based approach to perform the mapping. For example, first, the listener coordinate system is segmented into multiple areas (or grids), for example, based on perceptual relevancy, and then, for example, a ray is shot outward from each grid. For example, a hit of the ray on the 3D geometry indicates that the corresponding grid is within the boundary of its 2D projection from the listener's viewpoint. In other words, these grids are, for example, the spatial regions that should be included in the SESS processing.
   For example, apart from metadata, the Hom. SESS Synthesis algorithm (e.g. performed in Hom. SESS Synthesis unit 1034, e.g. corresponding or being a SESS rendering unit) also entails, for example, one or two audio signals to auralize a portal, for example, as Spatially Extended Sound Source. For example, to fulfill the prerequisite of the SESS algorithm, the two input signals should be (ideally) fully decorrelated (e.g. as shown with decorrelated input signals 1036). An example of this type of signal are two downmixed signals from the outputs of a Feedback Delay Network Reverberator, which is, for example, a natural choice for generation of late reverberation, considering that the inventive method is, for example, designed to simulate Acoustically Homogeneous Spaces and the propagation between them.
   For example, in the case the prepared input signals are not fully decorrelated (or there would only be a mono signal available, e.g. as shown with signal 1038), a second fully decorrelated signal can, for example, be derived from one existing input signal using a decorrelator (e.g. decorrelator 1040), for example, like the one described in European patent application EP21162142.0 titled “AUDIO DECORRELATOR, PROCESSING SYSTEM AND METHOD FOR DECORRELATING AN AUDIO SIGNAL” (Inventors: DISCH Sascha; ANEMÜLLER Carlotta; HERRE Jürgen). This allows the user to get two valid signals to input to the Hom. SESS Synthesis algorithm.
   For example, as a last step, both the metadata and audio signals are provided as input to the Hom. SESS Synthesis (or Homegenous Spatially Extended Sound Source Rendering, or Spatially Extended Sound Source rendering), which, for example, renders the binaural output of the portals like that described in EP3879856.

### In the Following Chapter ‘Aspects of the Disclosure’ Embodiments are Discussed or Respectively Further Discussed:

First, aspects of renderers according to embodiments, which may, for example, be or which are possibly (optionally) controlled by the bitstream element; e.g. a bitstream element according to embodiments of the disclosure:

A renderer that
Is, for example, equipped to render the virtual acoustic impact of more than one Acoustically Homogeneous Environment/the propagation of reverb of one room as perceived from outside this room (e.g. from another adjacent room) . . . as a sound source with spatial extent/size (rather than a point source)
   In an advantageous implementation, the sized source is (optionally) rendered as described in EP3879856, for example, to render the reverb portal as a Spatially Extended Sound Source.
Uses, for example, either 1. 2 (or more) decorrelated downmixes of the outputs, for example, from a (e.g. Feedback Delay Network) reverberator or 2. a single-channel signal together with its decorrelated version as input to a Spatially Extended Sound Source algorithm.
Optionally maps the geometry of the portal (for example, a representation of an Acoustically Homogeneous Space) onto a listener-centered coordinate system, for example, to identify the spatial sectors covered by it relative to the listener.
   In an advantageous implementation, the mapping method is (optionally) a ray-tracing based algorithm.
Optionally simulates portals (for example, of the following two types) as Spatially Extended Sound Sources, for example, in accordance to the listener's position and orientation:
   Type 1 portal represents, for example, an AHS with its entire geometry. It is, for example, characterized by seamless rendering of all AHS in the scene regardless of listener's position. When, for example, the listener is outside of the portal, its correct perceived size can, for example, be calculated based on its projection on the listener coordinate system. On the other hand, when, for example, the listener is inside the portal, it is, for example, covering the whole sphere of listener's head. As a result, type 1 portals can, for example, fully represent all AHSs in the scene.
   Type 2 portal represents, for example, an AHS with its part that is connected to the AHS in which the listener is located. For example, this type of portal outlines only the actual geometry extent that will be radiating sound from the represented AHS into the listener AHS (rather than, for example, the complete volume of AHS like with type 1). As a result, the list of portals may, for example, have to be updated each time the listener enters a different AHS to make sure all AHSs are represented stably and correctly relative to listener's position. In addition, radiation properties can optionally also be assigned onto each corresponding portal, for example, to make sure the sound propagating from it is attenuated and colorized appropriately. In other words, no further occlusion processing is needed on type 2 portals.
Optionally models the occlusion of type 1 portals, for example, by excluding or attenuating the occluded spatial regions of a portal, for example, through equalization depending on the occluder's absorption properties.
   In an advantageous implementation, the occlusion processing optionally re-uses the ray-tracing information obtained, for example, in the previous geometry mapping step to save computation.
Optionally allows smooth transitions in-and-out of and in-between multiple Acoustically Homogeneous Spaces.
   In an advantageous embodiment, the range of transition zone is optionally controlled by a parameter and can be optionally transmitted in the bitstream.

In the following, aspects of bitstreams according to embodiments of the disclosure are discussed:

A bitstream that includes, for example, the following information (or at least a part thereof):
The acoustic description of the acoustically homogeneous spaces (e.g. control parameters of a reverberator) (optional).
The geometry description of the acoustically homogeneous spaces (e.g. The vertices and faces of a mesh or the extents of a box . . . etc.) (optional)
Detail information regarding the acoustic relation between the spaces
   As an example, for any pair of such spaces which have a connecting portal, a propagation factor from space #1 to space #2 is transmitted, for example, as a measure of how much of the acoustic energy of space #1 is radiated into space #2 (and, for example, the other way round). In an advantageous embodiment, this can optionally be calculated based on the ratio of the connected surface area between the two spaces and the entire absorption surface area of space #1).
   As a second example, the range of a transition zone between the AHSs is optionally controlled by a parameter that can be optionally transmitted in the bitstream.

In the following embodiments according to the disclosure are further discussed:

It should be noted that any of the features, functionalities and details as disclosed in the following may be incorporated or used with any of the embodiments as disclosed herein, both individually and taken in combination. Accordingly any of the features, functionalities and details as disclosed in the above embodiments may be incorporated or used with any of the following embodiments both individually and taken in combination.

Embodiments according to the disclosure, e.g. renderers, may be configured to manage the status updating and signal mixing of portals. A portal may, for example, be a representation of an Acoustic Environment (AE) or of an AHS seen from the perspective of a listener external to the said AE or AHS. A Portal may be rendered as a Homogeneous Extended Sound Source or as a SESS.

Therefore, embodiments according to the disclosure may use one or more of the following data elements and variables:
Reverbld Unique ID of each AE or AHS in the scene
Portalltems Map storing key-value pairs where the key is the ID of a RI, e.g. render item, and the value is a RI.
PortalMap Map storing key-value pairs where the key is the Reverbld of an AE or AHS, and the value is a vector of Portalltem which shall be active when the listener is inside an AE or AHS.
PortalBySource Map storing key-value pairs where the key is the Reverbld of an AE or AHS, and the value is a vector of Portalltem, whose audio signal shall be downmixed from the respective AE's reverb output.
PortalRI One entry of Portalltems, which is a key-value pair, where the key is the ID of a RI, and the value is a RI.
listenerReverbld Unique ID of the AE or AHS that the listener is in.
allReverbldsInScene A vector with the unique IDs of all AEs or AHS in the scene.
currentSignal An output signal frame (e.g. 15 channels) from the current reverb instance.
reverbSignalOutput A vector of output signal frames from all reverb instance in the scene.
portalSignalBuffer The signal buffer of a RI.

In the following a stage of a renderer or a decoder comprising the renderer, according to embodiments is described:

During the initialization, the data of all portals and their associated AE or AHS may, for example, be read from a bitstream. Each Portal struct from the encoder may be reconstructed into the renderer representation of a Portalltems. The following description is split into two sections explaining the metadata handling in the update thread and the signal processing in the audio thread respectively.

In the following an optional example for an update thread processing according to embodiments is provided:

For each update, the stage may, for example, activate and deactivates Portalltems based on the AE or AHS the listener is in. This may be done by searching the PortalMap with the key, which is the Reverbld of the AE or AHS, in which the listener is. If the ID of a RI in Portalltems is included in the value, the RI is relevant for this AE or AHS, thus may, for example, be activated. Otherwise, it may, for example, be deactivated.

### Example

```
for portalRI in PortalItems {
    if portalRI.Id is in PortalMap[listenerReverbId]{
    portalRI.activate( );
  } else {
  portalRI.deactivate( );
  }
}
```

A portal may, for example, be a representation of an AE or AHS, so the audio signal of the Portalltems are copied from the reverb output of the corresponding AE or AHS.

In the following an optional audio thread processing according to embodiments is discussed:

There may, for example, originally be a predetermined number, e.g. 15, output channels from each reverberator instance, and only two signals may be needed for rendering a portal as Homogeneous Extent.

As mentioned in the Update Thread Processsing description above, the signal output of a reverb instance or even each reverb instance may, for example, be mapped to a corresponding RI in the Portalltems.

### Example

```
for ReverbId in allReverIdsInScene{
  currentSignal = reverbSignalOutput[ReverbId];
  for portalRI in PortalBySource[ReverbId]{
    portalSignalBuffer[portalRI.id].copyFrom(currentSignal);
  }
}
```

Furthermore, encoders according to embodiments are further discussed:

Optional portal creation according to embodiments:
This section describes how an encoder according to embodiments may, for example, generate portals based on the acoustic environments (AEs or AHS) in a scene. An important concept to keep in mind here is that a portal may be a representation of an AE or AHS. When the listener is not in a particular AE or AHS, but it is still acoustically relevant, it may be represented as a portal.

There may, for example, be three steps covering the main processes of generating portals:

Creation of the geometry of the porta (optional):
One portal geometry with unique portalExtentld may, for example, be generated from each AE or AHS in the scene. Its geometry can, for example, be obtained by shrinking the geometry of the corresponding portalParentEnvironment slightly, this may be done to avoid overlap between the geometry of the portal and potential occluding boundaries (e.g. walls).

Identification of the connection state between two portals (optional):
There may, for example, be three possible states of connection between two AEs or AHSs: not connected, connected with an opening, connected with an occluder (or, for example and in other words: closed). This step may, for example, utilize raytracing and/or voxelization techniques to identify potential empty spaces or geometries between each pair of AEs or of AHSs or between one AE or AHS and the ‘outside’ environment. Furthermore, it may, for example, provide an information of isConnectedWithOpening, and if this variable is true, also a location of the opening, i.e. openingPosX, and openingPosZ.

Creation of the portal struct containing all its metadata to be encoded (optional):
Metadata or for example, even all the metadata obtained through the above two steps may, for example, be organized into a structure for bitstream serialization. This step may, for example, take care of a) creating one portal struct with unique portalld for each portal geometry, b) assigning them under relevant acousticEnvironmentld (portals may, for example, be relevant for a specific acoustic environment if they are not created from the given AE or AHS), and c) calculating portalFactor for each opened connection based on the area of the opening, volume of the source AE or AHS and the absorption coefficient of the source AE or AHS estimated from RT60.

1. A renderer for rendering an acoustic scene,
wherein the renderer is configured to render an acoustic impact of a diffuse sound, which originates in a first spatial region and in a second spatial region, using a spatially extended sound source, and
wherein the renderer is configured to render the acoustic impact of the diffuse sound using a spatially extended sound source which is placed at a portal between the first spatial region and the second spatial region, and which reproduces the diffuse sound which originates from the first spatial region.

2. The renderer according to claim 1,
wherein the renderer is configured to render a direct-sound acoustic impact of a given sound source, which is located in the first spatial region, and in the second spatial region using a direct-sound rendering, and
wherein the renderer is configured to render a diffuse-sound acoustic impact of the given sound source in the second spatial region using the spatially extended sound source.

3. The renderer according to claim 1,
wherein the renderer is configured to apply a direct source rendering to a sound source signal of a given sound source, which is located in the first spatial region, in order to acquire a rendered direct sound source response at a listener position which is located in the second spatial region,
wherein the renderer is configured to apply a reverberation processing to the sound source signal of the given sound source, in order to acquire one or more reverberated versions of the sound source signal of the given sound source, and
wherein the renderer is configured to apply a spatially extended sound source rendering to the one or more reverberated versions of the sound source signal of the given sound source, in order to acquire a rendered diffuse sound response at the listener position which is located in the second spatial region.

4. The renderer according to claim 1,
wherein the renderer is configured to render an acoustic impact of a late reverberation, which is excited by a sound source located in the first spatial region, in the second spatial region, using the spatially extended sound source that reproduces the late reverberation.

5. The renderer according to claim 1,
wherein the renderer is configured to render the acoustic impact of the diffuse sound using a spatially extended sound source that comprises similar spectral content in each spatial region.

6. The renderer according to claim 1,
wherein the first spatial region is a first acoustically homogenous space, and
wherein the second spatial region is a second acoustically homogenous space.

7. The renderer according to claim 1,
wherein the first spatial region and the second spatial region are rooms which are acoustically coupled via a portal.

8. The renderer according to claim 1,
wherein the renderer is configured to render a plurality of spatially extended sound sources comprising one or more spatially extended sources, which are distant from a listener position, and one or more spatially extended sources, inside of which the listener position is located, using a same rendering algorithm, taking into account occlusions between the listener position and the one or more spatially extended sources which are distant from the listener position.

9. The renderer according to claim 1,
wherein the renderer is configured to perform a binaural rendering.

10. The renderer according to claim 1,
wherein the renderer is configured to determine in which spatial region relative to a listener's position or a listener's orientation, the spatially extended sound source where the reproduction of the diffuse sound lies, and to render the spatially extended sound source in dependence thereon.

11. The renderer according to claim 1,
wherein the renderer is configured to determine in which spatial region relative to a listener's position or a listener's orientation, the spatially extended sound source for the reproduction of the diffuse sound is occluded; and to render the spatially extended sound source in dependence thereon.

12. The renderer according to claim 1,
wherein the renderer is configured to determine in which spatial region relative to a listener's position or a listener's orientation, the spatially extended sound source for the reproduction of the diffuse sound lies using a ray-tracing based approach.

13. The renderer according to claim 1,
wherein the renderer is configured to determine in which spatial region relative to a listener's position or a listener's orientation, the spatially extended sound source for the reproduction of the diffuse sound is occluded using a ray-tracing based approach.

14. The renderer according to claim 1,
wherein the renderer is configured to determine, for a plurality of areas, whether a ray associated with a respective area and extending away from a listener's position hits the spatially extended sound source, to thereby determine in which spatial region relative to a listener's position and/or a listener's orientation, the spatially extended sound source for the reproduction of the diffuse sound lies.

15. The renderer according to claim 1,
wherein the renderer is configured to determine one or more auditory cue information items depending on the spatial region in which the spatially extended sound source for the reproduction of the diffuse sound lies, and
wherein the renderer is configured to process one or more audio signals representing the diffuse sound using the one or more auditory cue information items, in order to acquire a rendered version of the diffuse sound.

16. The renderer according to claim 1,
wherein the renderer is configured to update the determination, in which spatial region relative to a listener's position or a listener's orientation, the spatially extended sound source for the reproduction of the diffuse sound lies, in response to a movement of the listener,
wherein the renderer is configured to update the determination of the one or more auditory cue information items in response to a movement of the listener, and
wherein the renderer is configured to update the determination of the one or more cue information items in response to a change of the spatial region in which the spatially extended sound source for the reproduction of the diffuse sound lies.

17. An audio decoder, comprising:
a renderer according to claim 1,
wherein the audio decoder is configured to acquire a geometry description of a portal from a bitstream and to map the geometry of the portal onto a listener-centered coordinate system, in order to acquire a geometry description of the spatially extended sound source for the reproduction of the diffuse sound.

18. An audio encoder for encoding an audio scene,
wherein the audio encoder is configured to provide an encoded representation of one or more audio signals, and
wherein the audio encoder is configured to provide definitions of one or more spatially extended sound sources, wherein geometrical characteristics of the spatially extended sound sources are based on geometrical characteristics of portals between acoustically homogenous spaces.

19. The audio encoder according to claim 18,
wherein the audio encoder is configured to identify a plurality of acoustically homogenous spaces and one or more portals between the acoustically homogenous spaces, and to provide definitions of one or more spatially extended sound sources on the basis thereof, and
wherein geometrical characteristics of the one or more spatially extended sound sources are based on dimensions of the identified portals.

20. A method for rendering an acoustic scene,
wherein the method comprises rendering an acoustic impact of a diffuse sound, which originates in a first spatial region, in a second spatial region, using a spatially extended sound source, which is placed at a portal between the first spatial region and the second spatial region and which reproduces the diffuse sound which originates from the first spatial region.

21. A method for encoding an audio scene,
wherein the method comprises providing an encoded representation of one or more audio signals, and
wherein the method comprises providing definitions of one or more spatially extended sound sources, wherein geometrical characteristics of the spatially extended sound sources are based on geometrical characteristics of portals between acoustically homogenous spaces.

22. A non-transitory digital storage medium having stored thereon a computer program for performing the method for rendering an acoustic scene of claim 20, upon the computer program being run by a computer.

23. A non-transitory digital storage medium having stored thereon a computer program for performing the method for encoding an audio scene of claim 21, upon the computer program being run by a computer.

24. An audio bitstream, comprising:
an encoded description of one or more spatial regions; and
an encoded representation of an information describing an acoustic relation between at least two spatial regions,
wherein the encoded representation of spatial regions comprises a description of a portal between two spatial regions.

25. The audio bitstream according to claim 24,
wherein the audio bitstream comprises an encoded representation of a propagation factor describing an acoustic propagation from the first spatial region to the second acoustic region.

26. The audio bitstream according to claim 24,
wherein the audio bitstream comprises a propagation factor describing the amount or fraction of acoustic energy of a first spatial region is radiated into a second spatial region.

27. The audio bitstream according to claim 24,
wherein the audio bitstream comprises a propagation factor describing a ratio between a connected surface area between a first space and a second space and an entire absorption surface area of the first space.

28. The audio bitstream according to claim 24,
wherein the audio bitstream comprises a parameter describing a range of a transition zone between two spatial regions.
